(19) United States
(12) Patent Application Publication
(10) Pub. No.: US 2016/0154924 A1
(43) Pub. Date: Jun. 2, 2016

(54) SEMICONDUCTOR DESIGN METHOD AND COMPUTER-READABLE RECORDING MEDIUM

(71) Applicant: Socionext Inc., Yokohama-shi (JP)

(72) Inventor: Kaname Ozawa, Yokohama (JP)

(21) Appl. No.: 14/954,253

(22) Filed: Nov. 30, 2015

(30) Foreign Application Priority Data
Dec. 2, 2014 (JP) 2014-244162

(51) Int. Cl. G06F 17/50

(52) U.S. Cl. CPC G06F 17/5081; G06F 2217/82; G06F 2217/40

(57) ABSTRACT

A semiconductor design method is disclosed. Bumps are assigned to multiple Input and Output (I/O) sections of a chip. A plane is formed by deploying vias at locations of the bumps which are allocated to I/O sections of power supplies and grounds, with respect to a package on which the chip is mounted. An allocation of the bumps is changed with respect to the I/O sections of the power supplies and the grounds among the multiple I/O sections based on a number of the vias inside a void formed on the plane.

### CROSS-REFERENCE TO RELATED APPLICATIONS

This application is based upon and claims the benefit of priority of the prior Japanese Priority Application No. 2014-244162 filed on Dec. 2, 2014, the entire contents of which are hereby incorporated by reference.

### FIELD

The embodiment discussed herein is related to a semiconductor design method and a computer-readable recording medium.

### BACKGROUND

Recently, a semiconductor integrated circuit (hereinafter, called a “chip”) has been mounted on a substrate by a Ball Grid Array (BGA) due to an increase of electrodes, constraints of a mounting area, and the like.

The BGA reduces a mounting area more than a Quad Flat Package (QFP) in which lead terminals are arranged peripherally around a component. Due to a different architecture, related to wirings and connections from bumps on a chip to external terminals of a package substrate, various technologies are proposed.

A technology is known to verify whether connection nets from the bumps on the chip to the external terminals on the package substrate are violate a predetermined design rule.

Another technology is presented to calculate a noise risk for each of Input and Output (I/O) pads by using an inductance of an electrode pad and a drive factor for each of I/O cells, and to conduct an addition, a deletion, a location change of the electrode pad based on distribution of the noise risk.

Moreover, a technology and the like are presented in which it is determined whether a wire is passed through between pins in a planned printed circuit board according to a ball pitch, a pad diameter, and a ball column of the semiconductor package, and information pertinent to the I/O cell for each of the pins is reflected to a pin definition table.

### PATENT DOCUMENTS

Japanese Laid-open Patent Publication No. 2004-47829

Japanese Laid-open Patent Publication No. 2009-140225

Japanese Laid-open Patent Publication No. 2005-259036

### SUMMARY

According to one aspect of the embodiment, there is provided a semiconductor design method performed in a computer, the method including: assigning, by the computer, bumps to multiple Input and Output (I/O) sections of a chip; forming, by the computer, a plane by deploying vias at locations of the bumps which are allocated to I/O sections of power supplies and grounds, with respect to a package on which the chip is mounted; and changing, by the computer, an allocation of the bumps with respect to the I/O sections of the power supplies and the grounds among the multiple I/O sections based on a number of the vias inside a void formed on the plane.

According to another aspect of the embodiment, there is provided a layout display method for a semiconductor device performed in a computer, the method including: conducting, by the computer, a display control process that controls displays of a first layout of a chip and a second layout of a package mounted on the chip, wherein the display control process include displaying the first layout and the second layout by overlaying the first layout with the second layout.

The aspect and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a diagram illustrating a cross-sectional view of a package of FCBGA;

FIG. 2A and FIG. 2B are diagrams illustrating wiring examples;

FIG. 3 is a flowchart diagram for explaining a bump assignment process in a related art;

FIG. 4 is a diagram illustrating an inner chip wiring example in a case in which a ground bump and an I/O power supply bump are arranged at the scribe side;

FIG. 5A is a diagram illustrating a wiring example of a first layer of a package, FIG. 5B is a diagram illustrating an area around an arrangement location of a signal bump on a second layer of the package, and FIG. 5C is a diagram illustrating an area around an arrangement location of the signal bump on the third layer of the package;

FIG. 6 is a diagram illustrating an example of an inner package wiring at the first layer and the second layer;

FIG. 7 is a diagram illustrating an example of the inner package wiring being detoured on the second layer;

FIG. 8A is a diagram illustrating an area including a signal via on the second layer, and FIG. 8B is a diagram illustrating an area 9b including a signal via on the third layer;

FIG. 9A is a diagram illustrating an example of an inner chip wiring, FIG. 9B is a diagram illustrating an example of a plane of the second layer, and FIG. 9C is a diagram illustrating an example of displaying a chip wiring and a plane of the package by overlaying to each other;

FIG. 10 is a diagram illustrating a hardware configuration of a design apparatus;

FIG. 11 is a diagram illustrating a functional configuration example of the design apparatus;

FIG. 12 is a flowchart for explaining the entire process of a bump arrangement process;

FIG. 13A is a diagram for explaining a process at a side of the chip in step F1;

FIG. 13B is a diagram for explaining the process at a side of the package in step F1;

FIG. 14A is a diagram for explaining a process at the side of the chip in step F2;

FIG. 14B is a diagram for explaining a process at the side of the package in step F3;

FIG. 15A is a diagram for explaining a process at the side of the chip in step F4;

FIG. 15B is a diagram for explaining a process at the side of the package in step F4;

FIG. 16 is a flowchart for explaining a process at the side of the chip in step F5;

FIG. 17A is a diagram illustrating a bump allocation chart corresponding to a result example in a part of the chip 2;

FIG. 17B is a diagram enlarging a portion A of the bump allocation chart;

FIG. 18 is a diagram illustrating an example of a current loop area determination reference level;

FIG. 19A is a flowchart for explaining processes at the side of the package in steps F8 and F9;

FIG. 19B is a flowchart for explaining a process at the side of the chip in step F10;

FIG. 20 is a diagram illustrating an example of a level improvement;

FIG. 21 is a diagram illustrating comparison examples between the first and second bump assignments;

FIG. 22 is a diagram for explaining an arrangement method of the inner package wiring;

FIG. 23A is a diagram illustrating a screen displaying an layout at a package top view, and FIG. 23B is a diagram illustrating the screen displaying an layout at a chip top view;

FIG. 24A is a diagram illustrating the screen displaying the layout of the package at the package top view, and FIG. 24B is a diagram illustrating the screen displaying the layout of the package at the chip top view;

FIG. 25A is a diagram illustrating the screen which overlays and displays the layout of the chip and the layout of the package at the package top view in the assignment result display area 7a, and FIG. 25B is a diagram illustrating a case in which the chip top view is selected by clicking the view direction display area;

FIG. 26A is a diagram illustrating a screen which displays the layout of the chip and the layout of the package in parallel at the package top view, and FIG. 26B is a diagram illustrating the screen which displays the layout of the chip and the layout of the package in parallel at the chip top view;

FIG. 27 is a diagram for explaining a layout display process; and

FIG. 28 is a diagram for explaining the layout display process.

### DESCRIPTION OF EMBODIMENTS

First, an area bump structure will be briefly described. The area bump structure has been often used for a Flip Chip BGA (FCBGA) and the like. Due to an increase of Inputs/Outputs (I/Os), I/O signals and a power supply are arranged on bumps formed at deeper locations at a core side (inner locations toward a center of a core). Therefore, a resistance tends to be increased since a wire between the bump and the I/O becomes thinner. There is an influence of a power supply noise caused by an IR-drop due to the resistance increase. Waveform quality is likely to be degraded, and a timing violation is likely to be occurred because of delay variation.

Moreover, in a circuit design, the bumps are assigned by different tools in a package design and a chip design separately. In a situation in which a wiring density has been increased, it becomes difficult to conduct an effective wiring. Also, due to the increase of the I/Os, it becomes difficult to suppress the resistance increase of power supply wiring of an I/O section.

Even if the previously described technologies are applied, it is difficult to conduct an area bump assignment in consideration of wiring in a chip (hereinafter, called “inner-chip wiring”) and wiring in a package (hereinafter, called “inner-package wiring”). It is difficult to overcome the above described problems.

Hence, in one aspect, an objective of the embodiment is related to a semiconductor design method, a computer-readable recording medium, and a layout display method for a semiconductor device in which effective area bump assignment in consideration with the inner chip wiring and the inner package wiring is realized, and a semiconductor device is designed in which the resistance of the power supply wiring of the I/O section is suppressed.

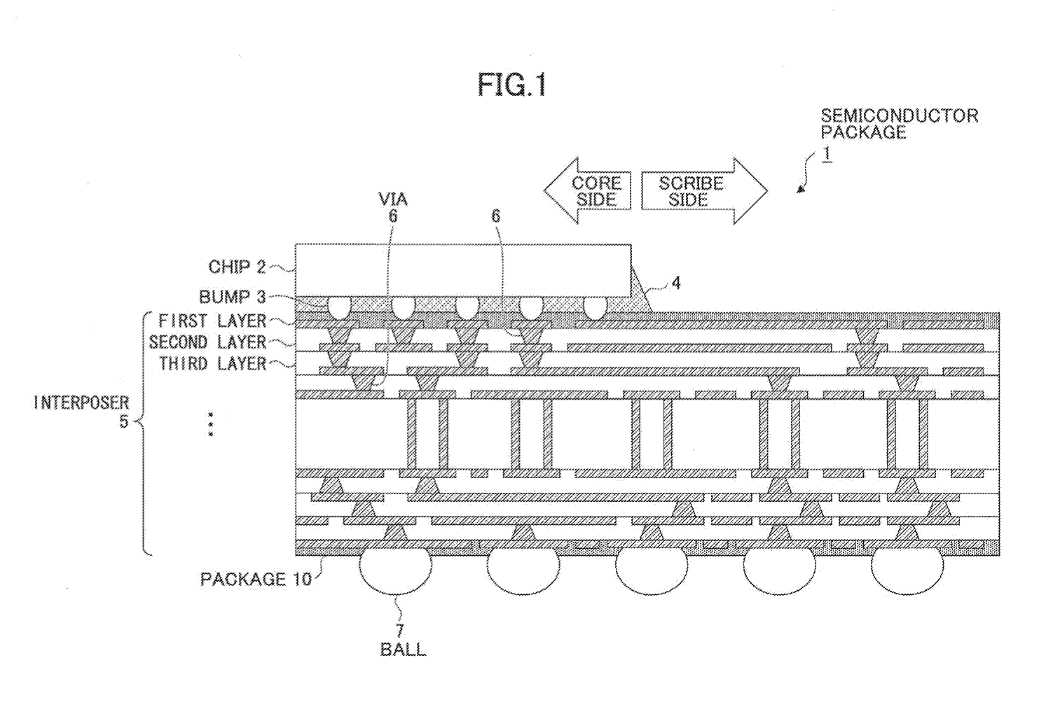

In the following, the embodiment of the present invention will be described with reference to the accompanying drawings. In the embodiment, a Flip Chip Ball Grid Array (FCBGA) as illustrated in FIG. 1 is exemplified as an example of a semiconductor package 1, and a design method of the semiconductor package 1 will be described.

FIG. 1 is a diagram illustrating a cross-sectional view of a package of FCBGA. In the semiconductor package 1 illustrated in FIG. 1, a state of mounting a chip 2 of the FCBGA is depicted. The chip 2 is electrically connected to an interposer 5, and a space between the chip 2 and the interposer 5 is reinforced by an underfill 4.

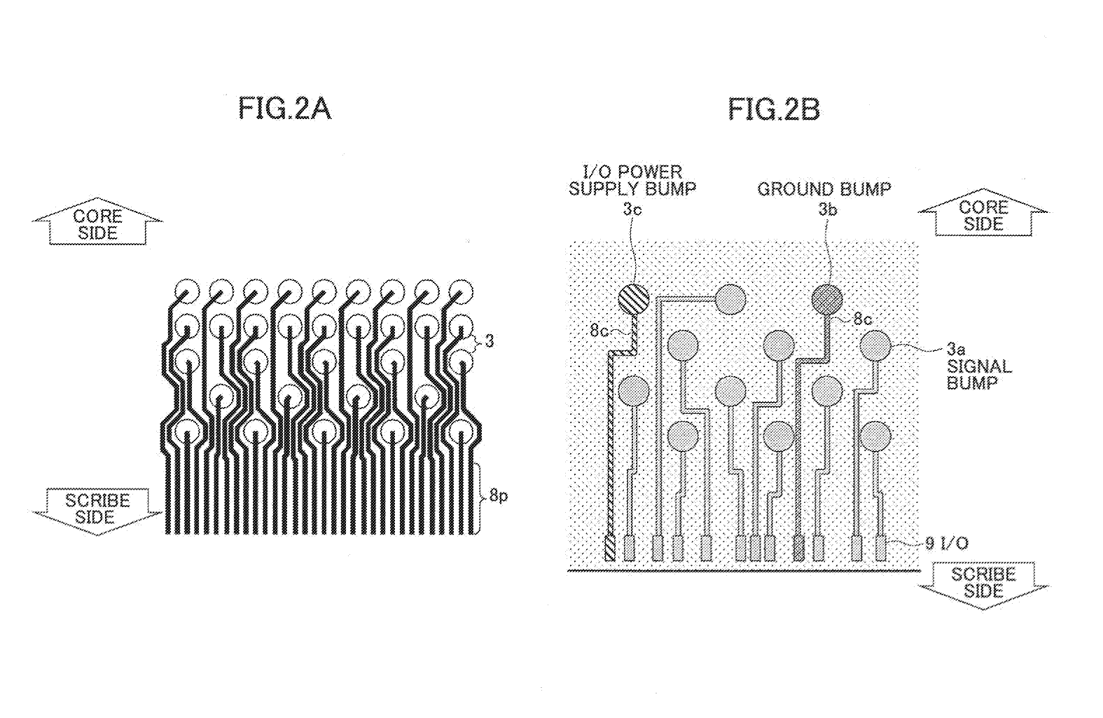

The chip 2 is connected to inner package wirings 8p (FIG. 2A) through bumps 3, and a package 10 is mounted on any kind of a substrate through balls (solder balls) 7. The interposer 5 includes multiple wiring layers: a first layer, a second layer, a third layer, . . . ), and wirings among the multiple layers are connected through vias 6. The wirings of each of the layers of the interposer 5 correspond to the inner package wirings 8p.

In the following, side surfaces of the chip 2 are regarded as a boundary, an inside of the chip 2 is regarded as a core side, and an outside of the chip 2 is regarded as a scribe side.

FIG. 2A and FIG. 2B are diagrams illustrating wiring examples. FIG. 2A illustrates the wiring example inside the package 10, and FIG. 2B illustrates the wiring example inside the chip 2. In the following, the bumps 3 may be distinguished by signal bumps 3a, ground bumps 3b, and an I/O power bump 3c.

Usually, connection of a signal wiring is prioritized in the package design. The signal bumps 3a are intensively arranged at the scribe side, and signal lines are drawn at the first layer. Due to this arrangement, the I/O power supply bump 3c is intensively arranged at the core side, and is connected to a terminal of the interposer 5 which is connected to the second layer or a lower layer through the vias 6.

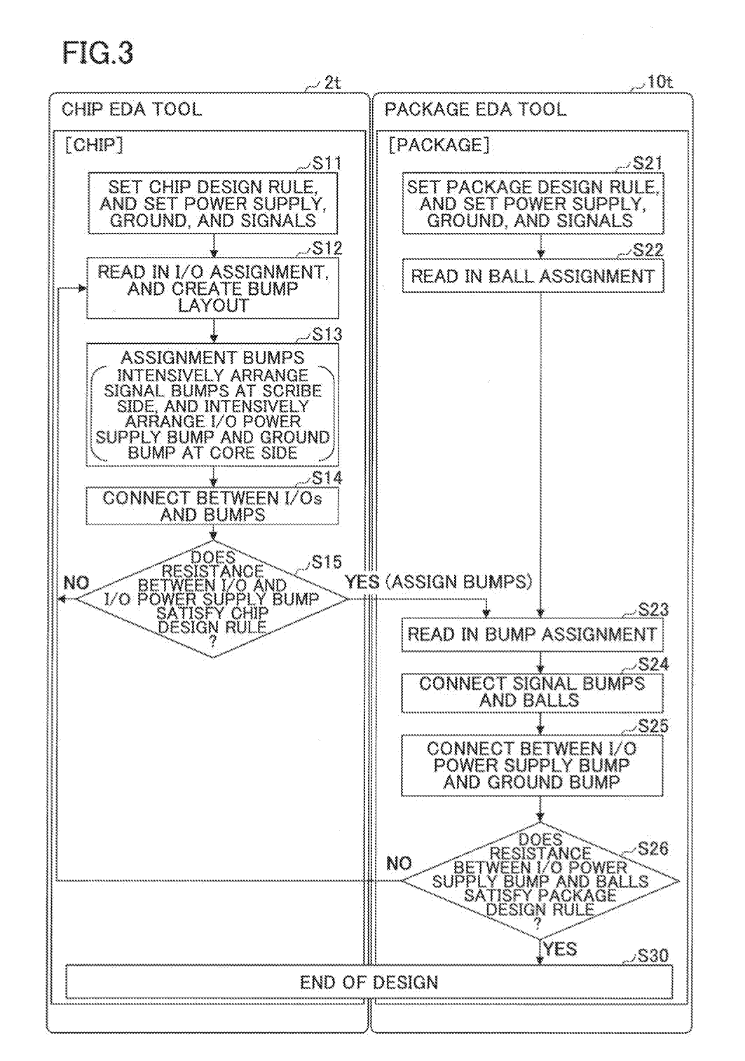

The above described bump assignment is conducted by an Electronic Design Automation tool at the chip 2 and the package 10, respectively. An example will be described as related art to the embodiment with reference to FIG. 3.

FIG. 3 is a flowchart diagram for explaining the bump assignment process in the related art. In FIG. 3, in the related art, the bump assignment process is separately conducted by an EDA tool at a chip side (hereinafter, called “chip EDA tool” 2t) and another EDA tool at a package side (hereinafter, called “package EDA tool” 10t).

The chip EDA tool 2t conducts the bump assignment process at a viewpoint (a chip top view) viewing the chip 2 from a top surface. The package EDA tool 10t connects the bumps 3 and balls 7 based on a result of the bump assignment process by the chip EDA tool 2t at a viewpoint (a package top view) viewing the package 10 from a top surface.

The chip EDA tool 2t sets a chip design rule, and sets the power supply, the ground, and signals (step S11). Also, the chip EDA tool 2t reads in an I/O assignment which defines an arrangement of I/Os 9, and creates a bump layout (step S12).

After that, the chip EDA tool 2t assigns the bumps 3 to the chip 2 (step S13). In step S13, the signal bumps 3a are intensively arranged to the scribe side, and the I/O power supply bump 3c and the ground bump 3b are intensively arranged to the core side.

Next, the chip EDA tool 2t connects between the I/Os 9 and the bumps 3 (step S14). After that, the chip EDA tool 2t determines whether a resistance between the I/O 9 and the I/O power supply bump 3c satisfies a design rule (step S15). When the resistance does not satisfy the design rule (NO of step S15), the chip EDA tool 2t goes back to step S12, and repeats the above described process in the same manner. On the other hand, when the resistance satisfies the design rule (YES of step S15), the chip EDA tool 2t outputs the bump assignment. At this stage, the bump assignment is temporarily defined.

On the other hand, the package EDA tool 10t designs a package design rule, and sets the power source, the ground, and the signals (step S21). The package EDA tool 10t reads in a ball assignment (step S22).

Moreover, the package EDA tool 10t reads on the bump assignment which is output by the chip EDA tool 2t (step S23). Next, the package EDA tool 10t connects between the signal bumps 3a and the balls 7 (step S24), and connects between each of the I/O power supply bump 3c and the ground bump 3b and the balls 7 (step S25).

After that, the package EDA tool 10t determines whether the resistance between the I/O power supply bump 3c and the ball 7 satisfies the package design rule (step S26). When the resistance satisfies the package design rule (YES of step S26), the design is completed (step S30).

On the other hand, when the resistance does not satisfy the package design rule (NO of step S26), the bump assignment process is repeated from step 12 at the side of the chip 2, so as to re-assign the bumps 3. A return to step S12 at the side of the chip 2 considerably consumes process time.

In a case in which there are not many signals, the problem related to the resistance of the wiring may not be significantly raised even in the above described bump assignment. In accordance with a recent increase of signals, the I/O power supply bump 3c is further pushed toward the center of the chip 2. As a result, the wiring between the I/Os and the bumps 3 in the chip 2 becomes longer, and the resistance of the I/O power supply is increased. It may be repeated to go back to step S12 at the side of the chip 2.

The wirings in the chip 2 (hereinafter, called “inner chip wirings” 8c) are not planarized and formed to be thicker like the inner package wirings 8p are. The wiring resistances are determined depending on distances between the bumps 3 and I/Os 9. A following case will be considered. In this case, in order to shorten the inner chip wirings 8c, the ground bump 3b and the I/O power supply bump 3c are arranged at the scribe side, and the signal bumps 3a are arranged at the core side.

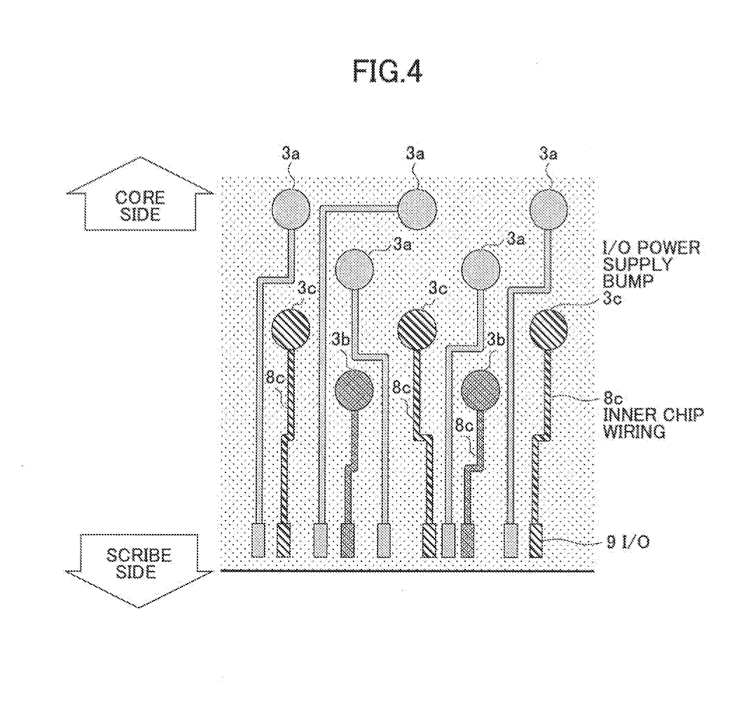

FIG. 4 is a diagram illustrating an inner chip wiring example in a case in which the ground bump and the I/O power supply bump are arranged at the scribe side. In the example illustrated in FIG. 4, the ground bump 3b and the I/O power supply bump 3c are arranged closer to the scribe side than the signal bumps 3a.

In this case, the inner chip wiring 8c of the ground bump 3b becomes shorter, and the wiring resistance is reduced. On the other hand, the signal bumps 3a are pushed further behind the ground bump 3b and the I/O power supply bump 3c at the core side.

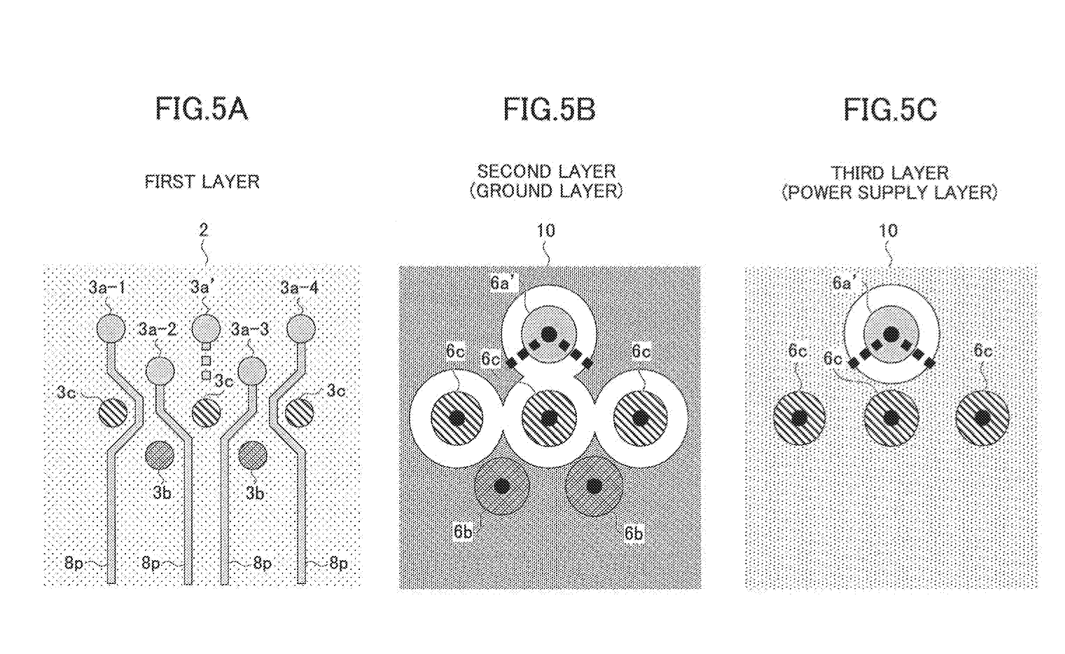

The inner package wiring example in a bump arrangement in FIG. 4 will be described with reference to FIG. 5A, FIG. 5B, and FIG. 5C. In FIG. 5A, FIG. 5B, and FIG. 5C, the first layer corresponds to a surface layer of the package 10, the second layer corresponds to the ground layer of the package 10, and the third layer corresponds to a power supply layer. In addition, an upper side corresponds to the core side, and a lower side corresponds to the scribe side.

FIG. 5A is a diagram illustrating a wiring example of the first layer of the package 10. As illustrated in FIG. 5A, the signal wirings from four signal bumps 3a-1, 3a-2, 3a-3, and 3a-4 are formed at the first layer. However, the signal line from the signal bump 3a′ is not drawn at the first layer. Signal wirings, which are not formed, are depicted by dashed lines. In this case, the signal wiring from the signal bump 3a′ is conducted at the second layer.

FIG. 5B is a diagram illustrating an area around an arrangement location of the signal bump 3a′ (FIG. 5A) on the second layer of the package 10. In FIG. 5B, a signal via 6a′ is regarded as a via which is to be connected with the signal bump 3a′ at the first layer.

As illustrated in FIG. 5B, in a case of attempting to draw the signal line at the second layer through the signal via 6a′ from the signal bump 3a′, the signal line is not drawn due to three I/O power supply bumps 3c arranged closer at the scribe side than the signal bump 3a′ on the first layer. Also, the signal line is not drawn because the I/O power supply vias 6c, which are connected to the I/O power supply bumps 3c, become walls. Signal wirings, which are not formed, are depicted by the dashed lines. Moreover, it may be attempted to conduct the signal wiring from the signal bump 3a′ on the third layer.

FIG. 5C is a diagram illustrating an area around an arrangement location of the signal bump 3a′ on the third layer of the package 10. In FIG. 5C, as illustrated in FIG. 5C, in a case of attempting to draw the signal line on the third layer through the signal via 6a′ from the signal bump 3a′, the signal wiring is not conducted since the I/O power supply via 6c becomes the wall. The signal wirings, which are not formed, are depicted by the dashed lines.

As described above, depending on the arrangements of the I/O power supply bumps 3c and the ground bumps 3b at the scribe side, the I/O power supply vias 6c and ground vias 6b, which are connected to the I/O power supply bumps 3c and the ground bumps 3b, respectively, become the walls which block conducting the signal wirings.

Moreover, due to the arrangement of the I/O power supply vias 6c being linked and/or the ground vias 6b being linked, a signal return path of the first layer is greatly lost. Hence, a characteristic of a signal is degraded.

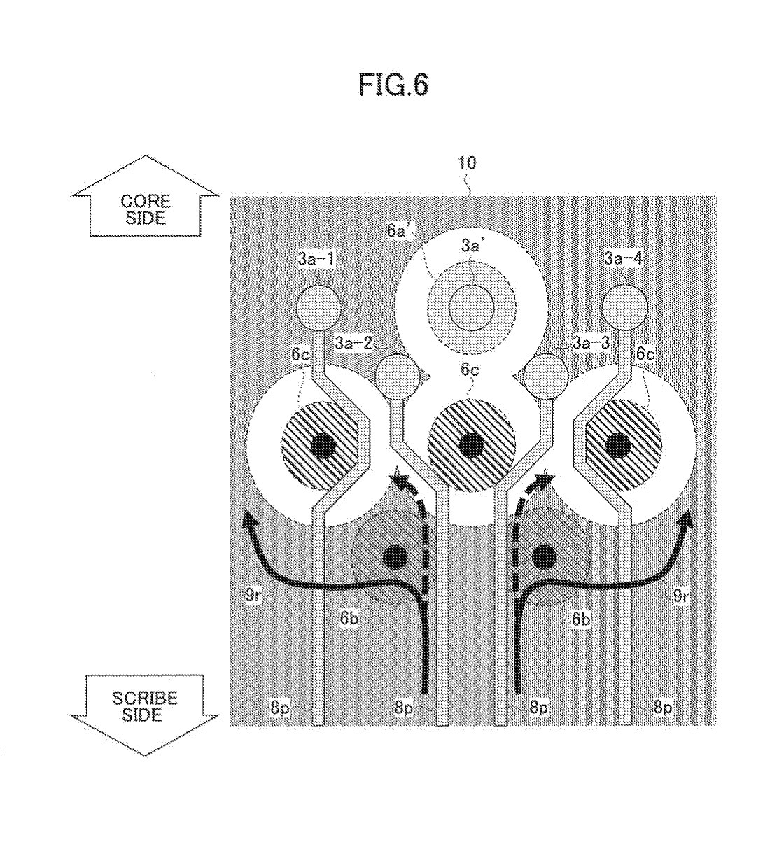

FIG. 6 is a diagram illustrating an example of the inner package wiring at the first layer and the second layer. In FIG. 6, the signal bumps 3a-1, 3a-2, 3a-3, 3a-4, and 3a′ on the first layer, the signal wirings from the signal bump 3a-1, 3a-2, 3a-3, and 3a-4, and arrangements of the signal via 6a′, the ground via 6b, and the I/O power supply via 6c on the second layer (the ground layer) are depicted by being overlaid.

Due to the linked I/O power supply vias 6c, return paths 9r may be greatly detoured on the first layer, and a signal quality may be degraded. In FIG. 6, desired return paths are depicted by the dashed lines. The return paths 9r being greatly detoured may cause problems in which loop areas electrically become larger, and values of inductances become greater. That is, noise becomes greater.

As described above, generally, a designer of the chip 2 does not know a design condition (including arrangements of vias 6a to 6c) of the package 10. Also, a designer of the package 10 does not know a design condition (including an arrangement of the signal bump 3a) of the chip 2.

As described above, in an environment in which the chip 2 and the package 10 are separately designed, an iterative confirmation of designs by both developers may frequently occur in order to correspond to the increase of the resistances of the I/O power supplies along with a further increase of the I/Os in the future. Hence, it may be difficult to sufficiently correspond to such a development circumstance.

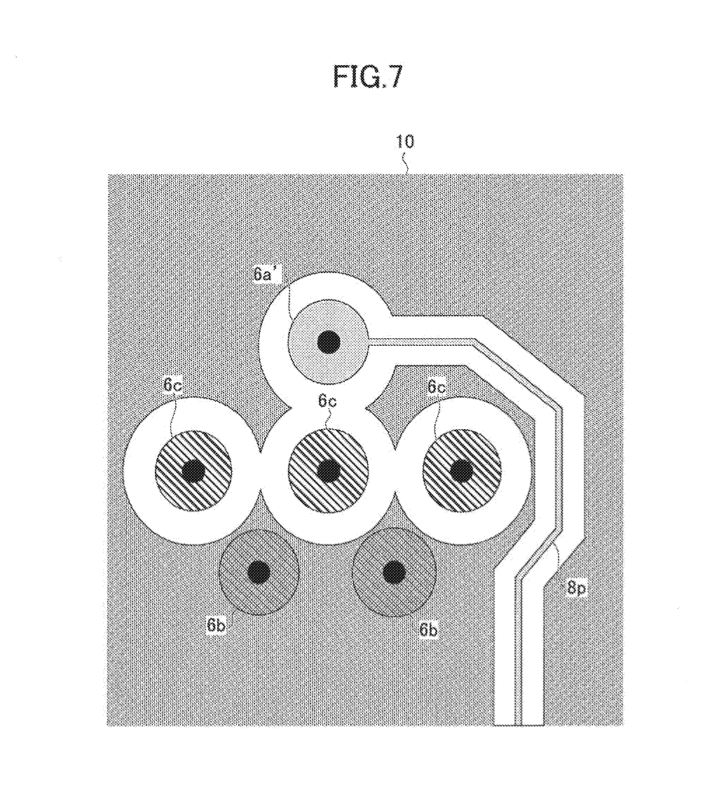

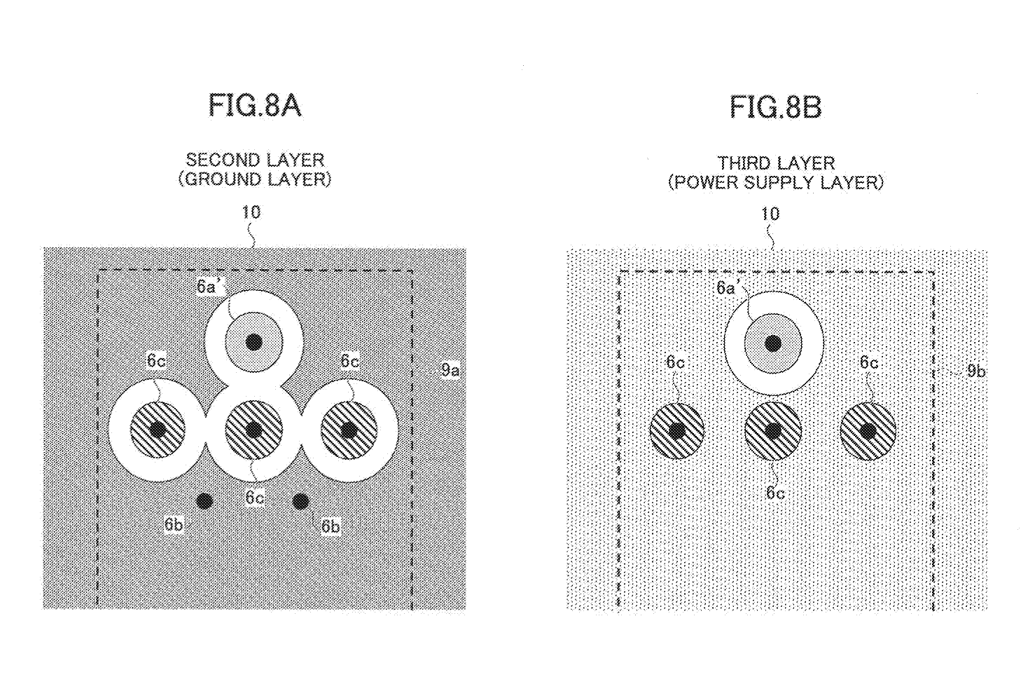

A case of conducting the wiring through the signal via 6a′ on the first layer or the second layer will be described with reference to FIG. 7 and FIG. 8. FIG. 7 is a diagram illustrating an example of the inner package wiring being detoured on the second layer. In FIG. 7, the signal line from the signal bump 3a′ is drawn to the second layer through the signal via 6a′, and is wired by detouring around the I/O power supply vias 6c being linked.

By the inner package wiring 8p being detoured, as described above, the return paths 9r may be occurred with respect to the inner package wiring 8p of the signal bump 3a-3 of the first layer, and the characteristic of the signal may be degraded.

Examples of areas will be described with reference to FIG. 8A and FIG. 8B. FIG. 8A illustrates an area 9a including the signal via 6a′ on the second layer (the ground layer). As depicted in FIG. 8A, there is no space at both right and left sides of the I/O power supply vias 6c being linked in the area 9a. Hence, it is difficult to detour and wire the signal line from the signal via 6a′.

FIG. 8B illustrates an area 9b including the signal via 6a′ on the third layer (the power supply layer). As depicted in FIG. 8B, there is no space at both right and left side of the I/O power supply vias 6c being linked in the area 9b. Hence, it is difficult to detour and wire the signal line from the signal via 6a′.

As illustrated in FIG. 8A and FIG. 8B, depending on a macro, there are cases in which the signal line is not deployed over a specific area at the side of the package 10. Under such a restriction, the I/O power supply vias 6c and/or the ground vias 6b may become obstacles. Hence, it may be difficult to wire the signal line.

In the embodiment, the bump assignment is conducted by the same EDA tool for the inner chip wiring 8c and the inner package wiring 8p. The arrangement of the I/O power supply bump 3c is replaced with the arrangement of the ground bump 3b so as to reduce current loop areas pertinent to the I/O power supply vias 6c. Therefore, it is possible to improve wiring properties of the signal lines. By the bump assignment having preferable wiring properties, even in a case of increasing the number of the I/Os, it is possible to reduce the increase of the wiring resistances of the I/O power supplies.

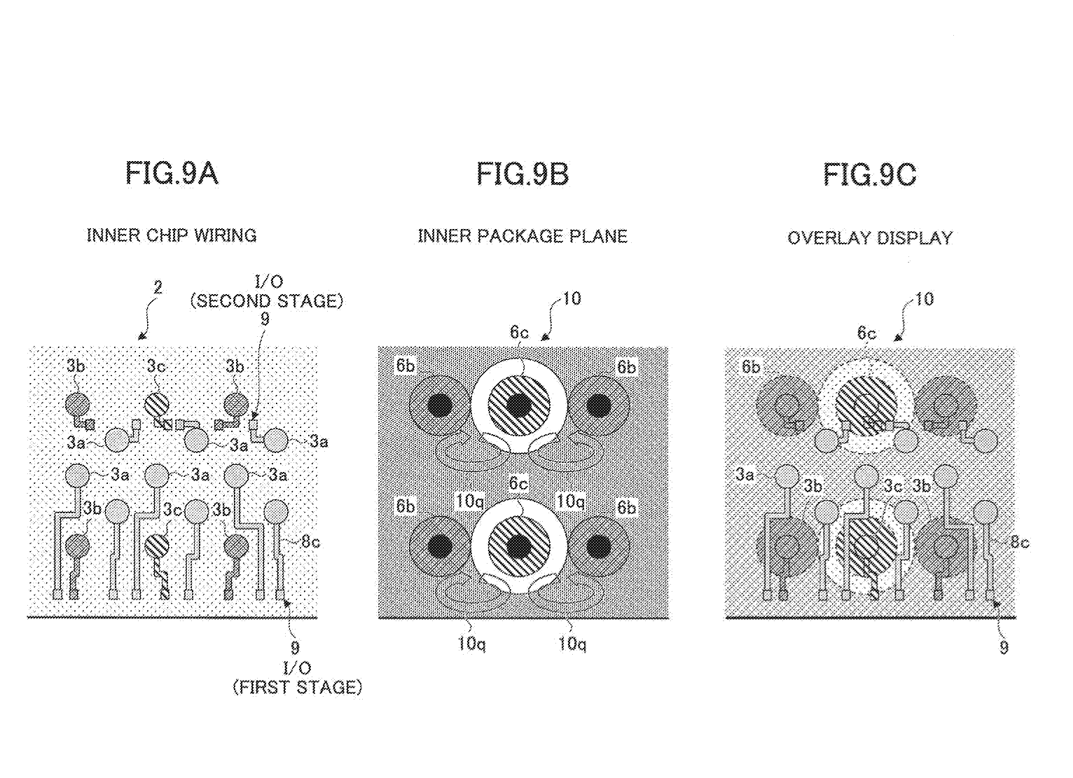

A bump assignment method in the embodiment will be briefly described with reference to FIG. 9A, FIG. 9B, and FIG. 9C. In FIG. 9A, a lower side corresponds to the scribe side and an upper side corresponds to the core side. It is assumed that the I/O assignment and a ball assignment have already or temporarily been determined.

In the embodiment, the I/O power supplies and the grounds are deployed at the bumps 3 having the shortest distance from the I/Os 9. The bumps 3 on which the I/O power supplies are deployed are indicated by the I/O power supply bumps 3c, and the bumps 3 on which the grounds are deployed are indicated by the ground bumps 3b. In the following, the signal bumps 3a, the ground bumps 3b, and the I/O power supply bumps 3c are collectively called the bumps 3.

Depending on the arrangements of the I/O power supplies and the grounds at the side of the chip 2, it is determined whether the current loop areas 10q (FIG. 9B) become lower than or equal to a reference.

When the current loop areas 10q are not lower than or equal to the reference, a distance from the I/Os 9 to the I/O power supply bumps 3c and the ground bumps 3b is further separated and the I/O power supply bumps 3c and the ground bumps 3b are alternately deployed. A replacement is conducted in the bump assignment so that the current loop areas 10q between the I/O power supplies and the grounds become lower than the reference.

An example of the inner chip wiring will be described with reference to FIG. 9A. In FIG. 9A, the I/Os 9 of the first stage and the second stage alone are depicted. The I/Os 9 may be deployed at the third stage or more. FIG. 9A illustrates distances from the I/Os 9 to the I/O power supply bumps 3c and the ground bumps 3b, and a result example of the bump assignment being adjusted by replacement depending on a determination result at the side of the package 10.

An example of a plane at the side of the package 10 will be described with reference to FIG. 9B. FIG. 9B illustrates an example of a plane of the second layer (a ground plane) corresponding to the bump assignment of which the current loop areas 10q are less than or equal to the reference. The I/O power supply bumps 3c and the ground bump 3b are alternately deployed.

FIG. 9C is a diagram illustrating an example of displaying a chip wiring and the plane of the package 10 by overlaying to each other. In the embodiment, the chip wiring and the package wiring are conducted by the same EDA tool 300. Accordingly, it is possible to sequentially verify the current loop areas 10q at the side of the package 10 in response to the bump assignment at the side of the chip 2.

In response to the arrangement of the bumps 3, at the side of the package 10, the arrangement of the vias 6 and the current loop areas 10q are verified, and the bump assignment is adjusted based on a verification result at the side of the chip 2. In response to the adjustment of the bump assignment, at the side of the package 10, the arrangement of the vias 6 and the current loop areas 10 are verified. In the embodiment, the above described processes are realized by a sequential computing process in the same EDA tool 300. It is possible to effectively conduct the bump assignment in which the current loop areas 10q are less than or equal to the reference. A design apparatus 100, which performs the above described processes, will be described below.

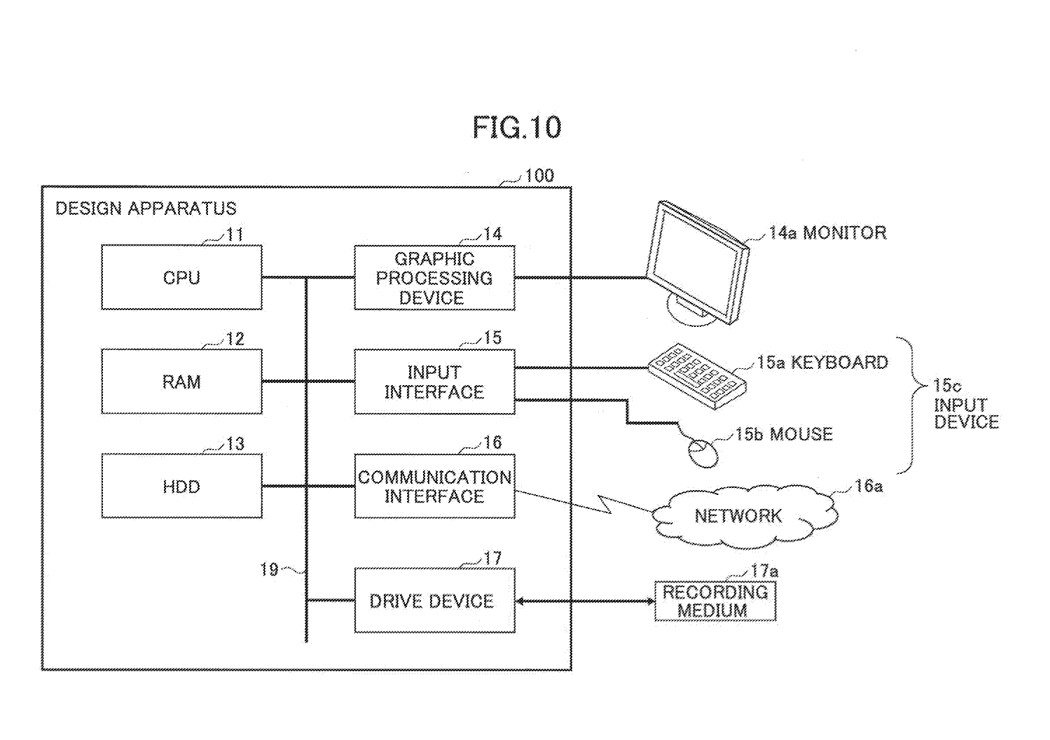

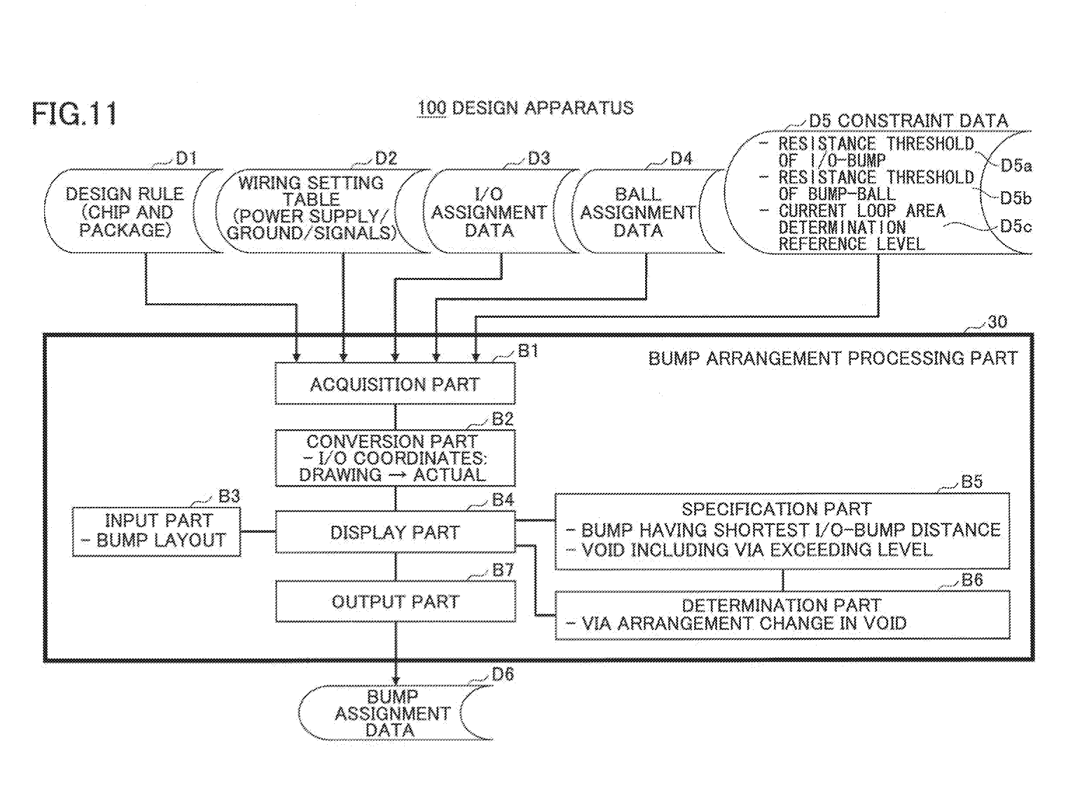

FIG. 10 is a diagram illustrating a hardware configuration of the design apparatus. In FIG. 10, the design apparatus 100 is regarded as an apparatus controlled by a computer, and includes a Central Processing Unit (CPU) 11, a Random Access Memory (RAM) 12, a Hard Disk Drive (HDD) 13, a graphic processing device 14, an input interface 15, a communication interface 16, and a drive device 17, which are mutually connected via a bus 19.

The CPU 11 is regarded as a processor which controls the design apparatus 100 in accordance with a program stored in the RAM 12. The RAM 12 stores or temporarily stores the program to be executed by the CPU 11, data used in a process of the CPU 11, data acquired in the process of the CPU 11, and the like.

The HDD 13 stores data such as programs to perform various processes. A part of the program stored in the HDD 13 is loaded into the RAM 12, and is executed by the CPU 11, so that various processes are realized.

The graphic processing device 14 conducts a graphic processing for displaying various information sets at a monitor 14a (corresponding to a display device) connected to the graphic processing device 14 under control of the CPU 11.

The input interface 15 receives various information sets which are input to the design apparatus 100 by a user using a keyboard 15a, a mouse 15b, or the like connected to the input interface 15. The keyboard 15a, the mouse 15b, or the like correspond to an input device 15c.

The communication interface 16 conducts wired or wireless communications through a network 16a.

The program realizing the process conducted by the design apparatus 100 may be provided by a recording medium 17a such as a Compact Disc Read-Only Memory (CD-ROM) or the like. The recording medium 17a may be formed by a non-transitory (or tangible) computer-readable recording medium.

The drive device 17 interfaces between the recording medium 17a and the design apparatus 100.

The program realizing the various processes according to the embodiment is stored in the recording medium 17a. The program stored in the recording medium 17a is installed into the drive device 17. The installed program becomes executable for the design apparatus 100.

It is noted that the recording medium 17a for storing the programs is not limited to the CD-ROM, and any types of computer-readable recording media may be used. As the computer-readable recording medium, a Digital Versatile Disk (DVD), a portable recording medium such as a Universal Serial Bus (USB) memory, or a semiconductor memory such as a flash memory may be used.

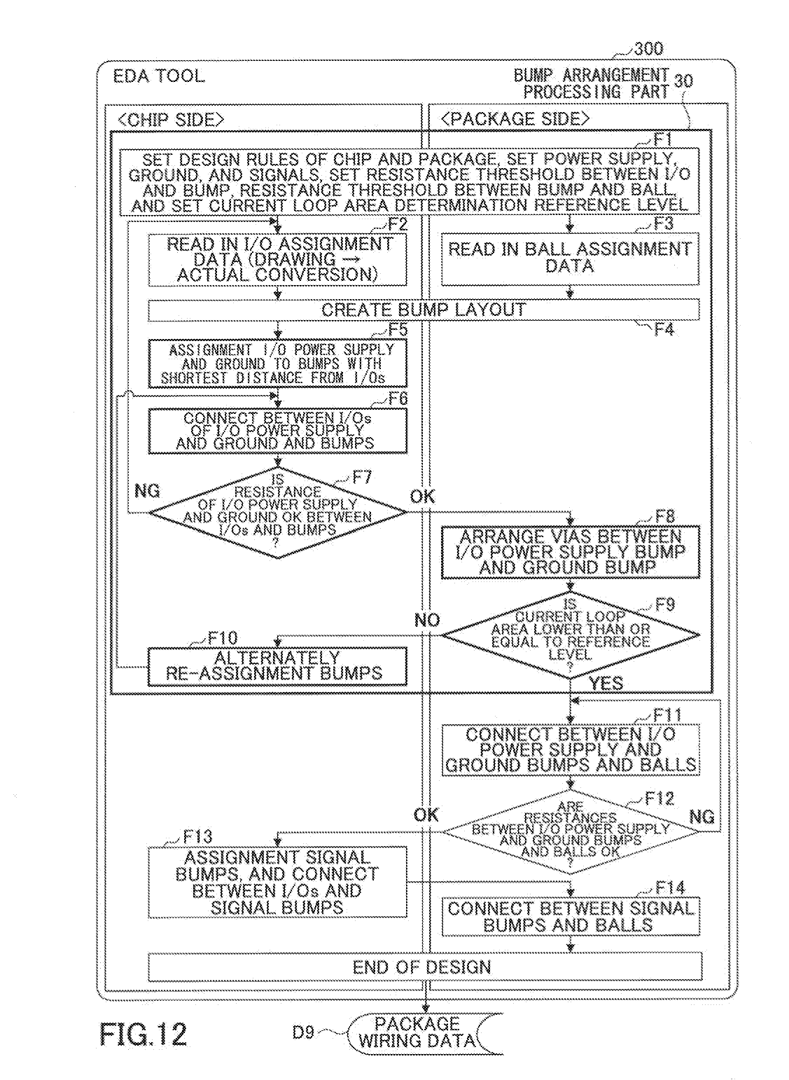

FIG. 11 is a diagram illustrating a functional configuration example of the design apparatus. In FIG. 11, the design apparatus 100 mainly includes a bump arrangement processing part 30. The bump arrangement processing part 30 corresponds to a part of an EDA tool 300 (FIG. 12). The bump arrangement processing part 30 includes an acquisition part B1, a conversion part B2, an input part B3, a display part B4, a specification part B5, a determination part B6, and an output part B7.

The HDD 13 stores a design rule D1, a wiring setting table D2, I/O assignment data D3, ball assignment data D4, constraint data D5, ball assignment data D6, and the like.

The acquisition part B1 acquires various sets of data for conducting a bump assignment process. By the acquisition part B1, the design rule D1, the wiring setting table D2, the I/O assignment data D3, the ball assignment data D4, constraint data D5, and the like are read into the bump assignment processing part 30 in response to the various processes.

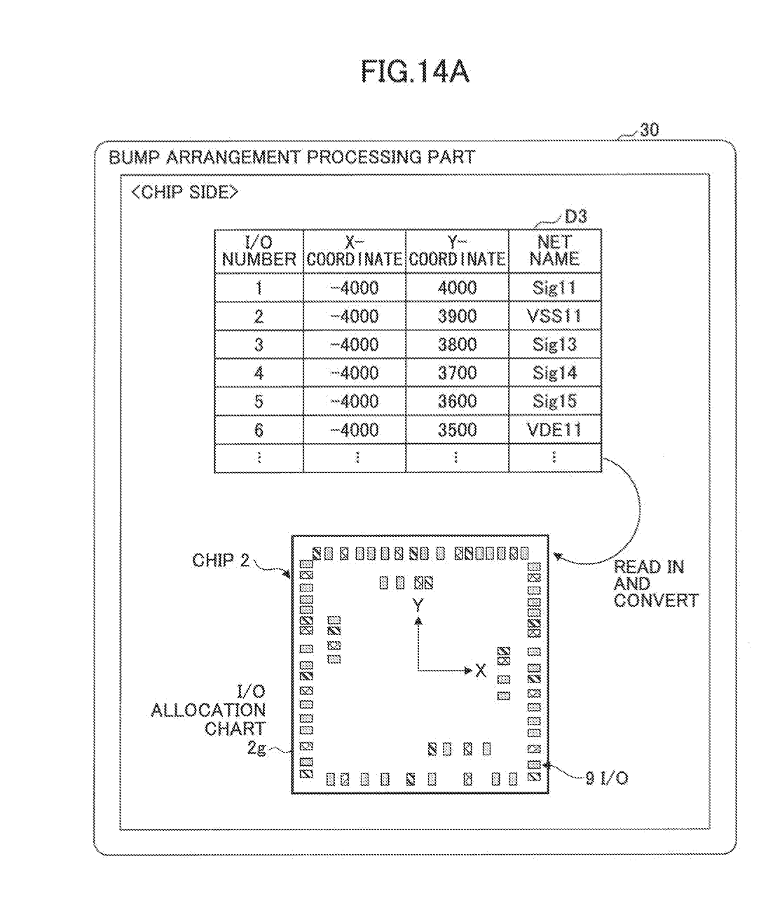

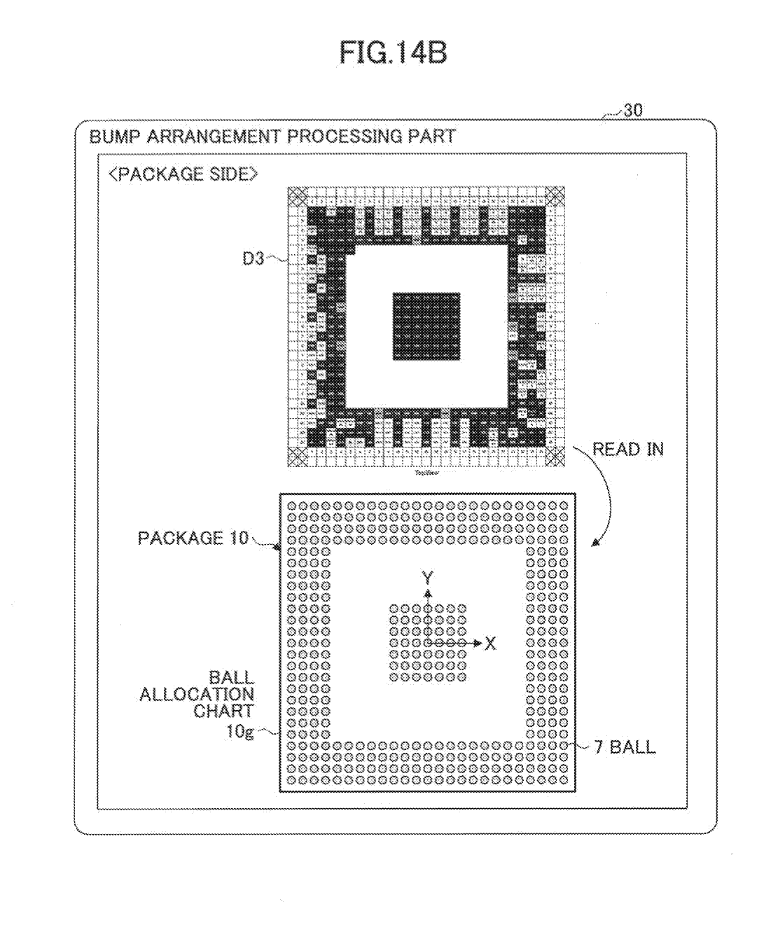

The conversion part B2 creates an I/O allocation chart 2g (FIG. 14A) from the I/O assignment data D3, and acquires actual coordinates of I/Os 9 by converting I/O coordinates (Drawing->Actual). Also, the conversion part B2 creates an ball allocation chart 10g (FIG. 14B) from the ball assignment data D4, and acquires actual coordinates of the bumps 3 by converting bump coordinates (Drawing->Actual).

The input part B3 receives an instruction of the bump layout from the designer. The input part B3 displays a setting screen of the bump layout at the monitor 14a, and acquires setting information pertinent to the bump layout input by the designer from the input device 15c of the keyboard 15a or the mouse 15b.

The display part B4 displays the I/O allocation chart 2g (FIG. 14A) indicating the arrangement of I/Os 9 of the chip 2, the ball allocation chart 10g (FIG. 14B) indicating the arrangement of the balls 7 of the package 10, and the like at the monitor 14a. The I/O allocation chart 2g (FIG. 14A) and the ball allocation chart 10g (FIG. 14B) are based on a view from a top surface of the package 10 (a package top view).

The specification part B5 specifies the bump 3 having the shortest distance between the I/O 9 and the bump 3. Also, the specification part B5 specifies a void including one or more vias 6 and exceeding a current loop area determination reference level D5c of the constraint data D5.

The determination part B6 changes the arrangement of the one or more vias 6 in the void specified by the specification part B5.

The output part B7 outputs a result by the bump arrangement process. The ball assignment data D6 is output and stored in the HDD 13.

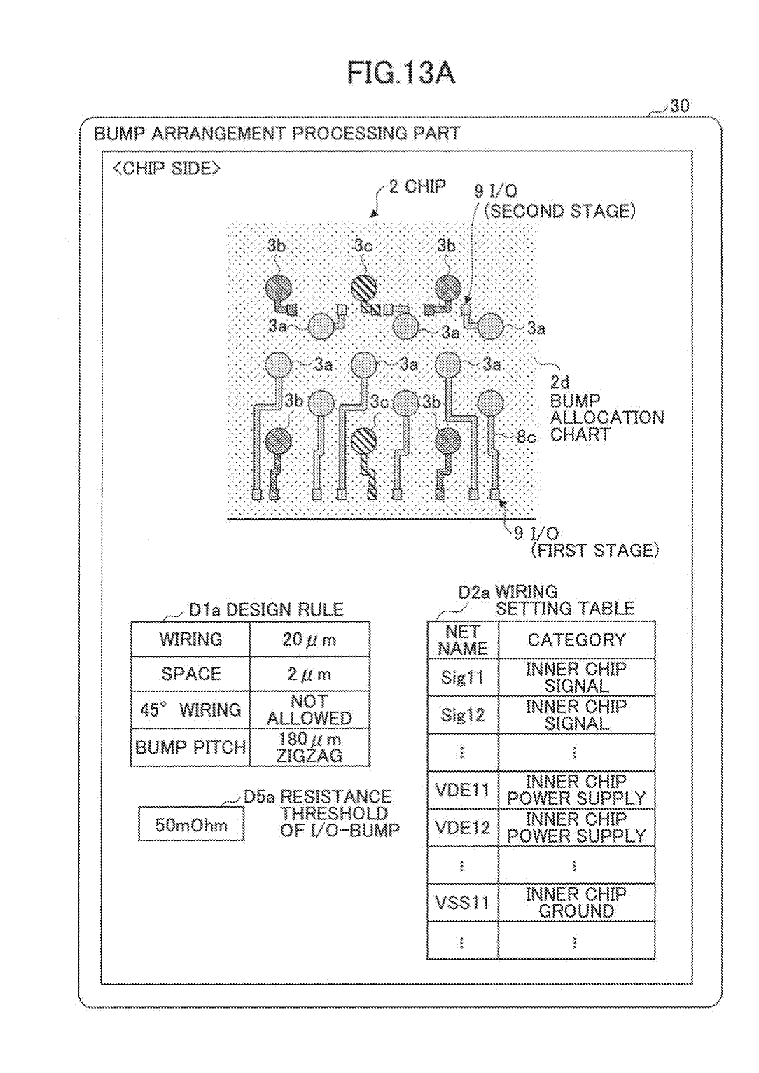

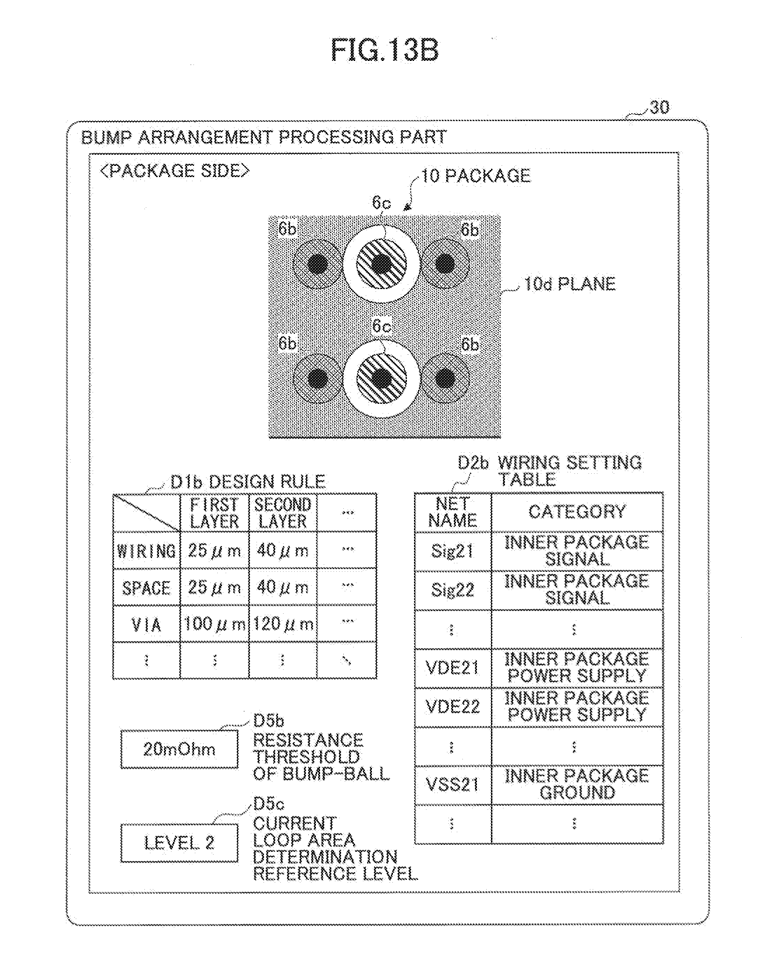

The design rule D1 includes a design rule D1a (FIG. 13A) of the chip 2, and a design rule D1b(FIG. 13B) of the package 10.

The wiring setting table D2 is regarded as a table which stores a net category by associating with a net name for each of nets, and includes a wiring setting table D2a (FIG. 13A) pertinent to the wirings of the chip 2 and a wiring setting table D2b (FIG. 13B) pertinent to the wirings of the package 10.

The wiring setting table D2a (FIG. 13A) corresponds to a table which is acquired by extracting records including a string “chip” in the category from the wiring setting table D2. The wiring setting table D2b (FIG. 13B) corresponds to a table which is acquired by extracting records including a string “package” in the category from the wiring setting table D2.

The I/O assignment data D3 includes arrangement information for each of I/Os 9 deployed on the chip 2.

The ball assignment data D4 include arrangement information of the balls 7 deployed on the package 10 (FIG. 14B).

The constraint data D5 includes a resistance threshold D5a of the I/O-bump of the chip 2, a resistance threshold D5b of the bump-ball of the package 10, a current loop area determination reference level D5c, and the like.

The bump arrangement process conducted by the bump arrangement processing part 30 will be described with reference to FIG. 12. FIG. 12 is a flowchart for explaining the entire process of the bump arrangement process. In FIG. 12 and following flowcharts, the arrangement will be conducted at the package top view.

In FIG. 12, the acquisition part B1 of the bump arrangement processing part 30 sets, from the HDD 13, the design rule by using the design rule D1 of the chip 2 and the package 10, sets the power supply, the ground, and the signals by using the wiring setting table D2, and sets the resistance threshold D5a between the I/Os 9 and the bumps 3 for the chip 2, the resistance threshold D5b between the bumps 3 and the balls 7 for the package 10, and a level as the reference for determining the current loop area 10q by using the constraint data D5 (step F1).

The acquisition part B1 reads in the I/O assignment data D3, the conversion part B2 creates the I/O allocation chart 2g (FIG. 14A), and the display part B4 displays the I/O allocation chart 2g (FIG. 14A) (step F2). In step F2, the conversion part B2 acquires the actual coordinates of the I/Os 9 by converting the I/O coordinates (Drawing->Actual).

Also, the acquisition part B1 reads in the ball assignment data D3 (step F3). Then, the conversion part B2 creates the ball allocation chart 10g (FIG. 14B), and the display part B4 displays the ball allocation chart 10g (FIG. 14B) at the monitor 14a.

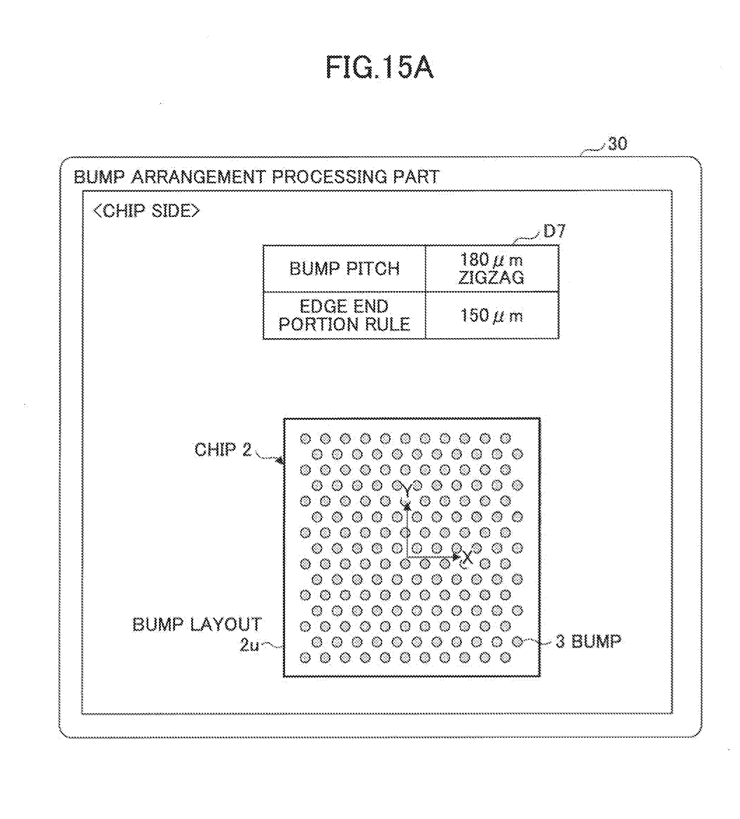

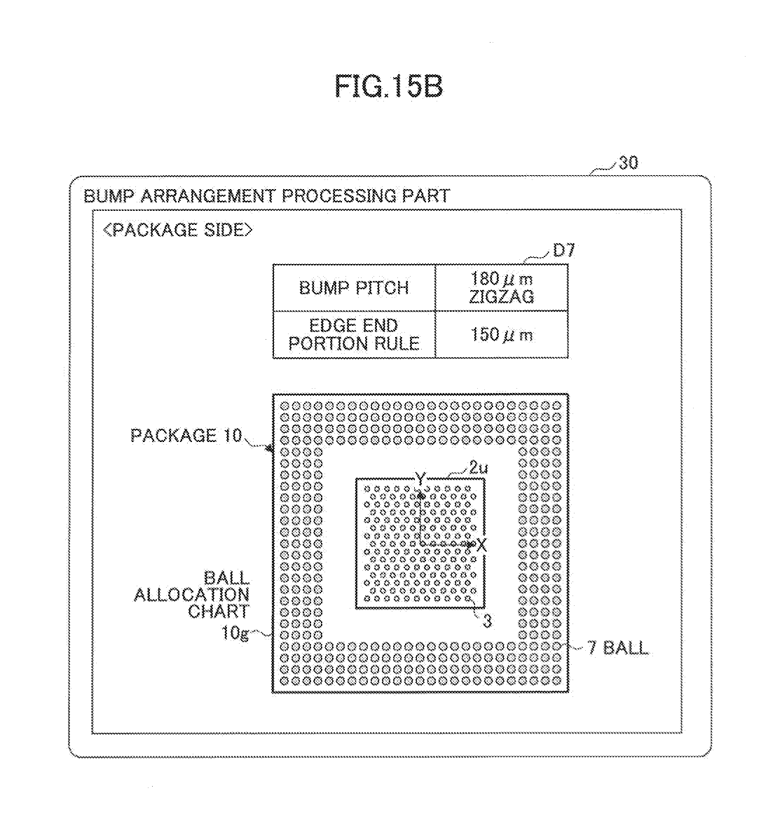

After that, when receiving an instruction including bump layout information D7 (FIG. 15A) set by the developer, the input part B3 creates a bump layout 2u (FIG. 15A) based on the bump layout information D7 (step F4). The bump layout 2u is displayed at the monitor 14a by the display part B4.

The specification part B5 assigns the I/O power supplies and the grounds to the bumps 3 with the shortest distance from the I/Os 9 (step F5). An assignment state is displayed by the display part B4. Moreover, the specification part B5 connects between the I/Os 9 specified in step F5) and the bumps 3 (step F6). A connection state is displayed by the display part B4.

After that, the specification part B5 determines whether resistances between the I/Os 9 of the I/O power supplies and the grounds and the bumps 3 satisfy the resistance threshold D5a (step F7). It is confirmed whether there is the bump 3 exceeding the resistance threshold D5a. When there is the bump 3 exceeding the resistance threshold D5a (NG of step F7), the bump arrangement processing part 30 goes back to step F2, and repeats the above described processes in the same manner. The I/O assignment data D3 may be reviewed by the designer.

On the other hand, when there is no bump 3 exceeding the resistance threshold D5a (OK of step F7), the vias 6 are deployed at the side of the package 10.

The specification part B5 deploys the vias 6 at locations of the bumps 3 of the I/O power supply and the ground (step F8). After that, the specification part B5 confirms whether each of the current loop areas 10q is lower than or equal to the current loop area determination reference level D5c (step F9).

When there is the current loop area 10q exceeding the current loop area determination reference level D5c (NO of step F9), the EDA tool 300 goes back to a process at the side of the chip 2, and the specification part B5 re-allocates the bumps 3 to alternately arrange the I/O power supply and the ground (step F10).

In this case, the void, which includes the via 6 and exceeds the current loop area determination reference level D5c, is specified, and the specified void is distinguishably displayed at the monitor 14a by the display part B4. Moreover, a result from re-allocating the bumps 3 is displayed at the monitor 14a in an allocation state in which the I/O power supply bumps 3c and the ground bumps 3b are alternately arranged.

On the other hand, when each of the current loop areas 10q is lower than or equal to the current loop area determination reference level D5c (YES of step F9), the bump assignment on the chip 2 and a via arrangement in the package 10 are completed, and the bump arrangement processing part 30 terminates the bump arrangement process.

The EDA tool 300 connects the I/O power supply bumps 3c and the ground bumps 3b to the balls 7 (step F11), and determines whether resistances between the I/O power supply bumps 3c and the ground bumps 3b and the balls 7 satisfy the resistance threshold D5a (step F12).

When the resistances do not satisfy the resistance threshold D5a (NG of step F12), the EDA tool 300 goes back to step F11, and re-connects from the I/O power supply bumps 3c and the ground bumps 3b to the balls 7 until the resistances satisfy the resistance threshold D5a.

When the resistances satisfy the resistance threshold D5a (OK of step F12), the EDA tool 300 assigns the signal bumps 3a on the chip 2, and connects between the I/Os 9 and the signal bumps 3a (step F13).

After that, the EDA tool 300 connects the signal bumps 3a to the balls 7 at the package 10 (step F14). The design by the EDA tool 300 is completed. Package wiring data D9 are output.

The package wiring data D9 may include wiring data for an inside of the chip 2 and wiring data for an inside of the package 10. In the package wiring data D9, the connection information is indicated by the net name of the wiring setting table D2. The wiring data for the inside of the chip 2 are extracted from the package wiring data D9 by using the net name included in the wiring setting table D2a (FIG. 13A) which is created by extracting records indicating “chip” in the category. Similarly, the wiring data for the inside of the package 10 are extracted from the package wiring data D9 by using the net name included in the table wiring setting table D2b (FIG. 13B) which is created by extracting records indicating “package” in the category.

In the bump arrangement process by the bump arrangement processing part 30, first, in step F7, the resistances between the I/Os 9 of the I/O power supplies and the grounds and the I/O power supply bumps 3c and the grounds bumps 3b are checked. Based on a check result, it is possible to reduce the resistances by shortening the wirings inside the chip 2.

Second, in step F8, the current loop areas 10q are verified in response to the assignments of the I/O power supply bumps 3c and the ground bumps 3b. It is possible to reduce the wiring resistances of the package 10.

Third, in step F10, related to the vias 6 in the specified void, the bumps 3 are re-assigned so that the I/O power supplies and the grounds are alternated. The wiring resistances inside the chip 2 may be increased. However, it is possible to make a balance between the wiring resistances of the chip 2 and the wiring resistances of the package 10.

In the following, processes in the above described steps F1 through F14 conducted by the bump arrangement processing part 30 in FIG. 12 will be described in detail. A process in step F11 will be described with reference to FIG. 13A and FIG. 13B. FIG. 13A is a diagram for explaining the process at the side of the chip 2 in step F1. FIG. 13B is a diagram for explaining the process at the side of the package 10 in step F1.

In step F1 in FIG. 12, the design rule D1a, the wiring setting table D2a, and the resistance threshold D5a of the I/O-bump, which are related to the chip 2, are set by the acquisition part B1.

In FIG. 13A, a bump allocation chart 2d is exemplified, and various settings pertinent to the chip 2 will be described. The bump allocation chart 2d depicts a part of the chip 2. In the bump allocation chart 2d, an upper side corresponds to the core side, and a lower side corresponds to the scribe side.

The design rule D1a defines the design rule of the chip 2, and corresponds to a part of the design rule D1a. In this example, the design rule D1a defines that the wiring is 20 μm in width, a space is 2 μm, a 45° wiring is not allowed to be used, a bump pitch is 180 μm zigzag, and the like. The 180 μm zigzag indicates to deploy the bumps 3 on a zigzag lattice with a 180 μm bump pitch. Instead of the zigzag lattice, a tetragonal lattice may be defined.

The wiring setting table D2a defines wiring settings for the chip 2 in the wiring setting table D2. The wiring setting table D2a includes items of “NET NAME”, “CATEGORY”, and the like. The item “NET NAME” indicates a wiring name which specifies the wiring connecting between the I/O 9 and the bump 3, and the item “CATEGORY” indicates the category of the wiring specified by the item “NET NAME”. In this example, the wiring of the net name “Sig11” is classified into a category “INNER CHIP SIGNAL”, the wiring of the net name “VDE11” is classified into a category “INNER CHIP POWER SUPPLY”, and the wiring of the net name “VSS11” is classified into a category “INNER CHIP GROUND”.

The resistance threshold D5a for the resistances of the I/O-bump defines an allowable resistance value between the I/Os 9 and the bumps 3 in the constraint data D5. The resistance threshold D5a for the resistances of the I/O-bump is referred to in step F7. In this example, in a case of exceeding 50 mOhm, it is determined that constraints of the chip 2 are not satisfied.

Connections depicted in the bump allocation chart 2d are conducted in accordance with the design rule D1a, the wiring setting table D2a, and the resistance threshold D5a for the resistances of the I/O-bump. The signal bumps 3a correspond to the bumps 3 connected to the I/Os 9. The ground bumps 3b correspond to the bumps 3 connected to the I/Os 9 of the grounds. The I/O power supply bumps 3c correspond to the bumps 3 connected to the I/Os 9 of the I/O power supplies. The bump assignment determines that each of the bumps 3 is to be connected (allocated) to which I/O type of the I/O 9.

In FIG. 13B, a plane 10d of the second layer is exemplified, and various settings pertinent to the package 10 will be described. The plane 10d depicts a part of the second layer of the package 10, In the plane 10d, an upper side corresponds to the core side, and a lower side corresponds to the scribe side.

The design rule D1b defines the design rule of the package 10, and corresponds to a part of the design rule D1. The design rule D1b defines the width of the wiring, the space, a diameter of the via 6, and the like. In this example, the width of the wiring is 25 μm, the space is 25 μm, the diameter of the via 6 is 100 μm, and the like.

The wiring setting table D2b defines wiring settings for the package 10 in the wiring setting table D2. The wiring setting table D2b includes items of “NET NAME”, “CATEGORY”, and the like. The item “NET NAME” indicates a wiring name which specifies the wiring connecting to the bump 3 through the via 6, and the item “CATEGORY” indicates the category of the wiring specified by the item “NET NAME”. In this example, the wiring of the net name “Sig21” is classified into a category “INNER PACKAGE SIGNAL”, the wiring of the net name “VDE21” is classified into a category “INNER PACKAGE POWER SUPPLY”, and the wiring of the net name “VSS21” is classified into a category “INNER PACKAGE GROUND”.

The resistance threshold D5b for the resistances of the bump-ball defines an allowable resistance value between the bumps 3 and the balls 7 in the constraint data D5. The resistance threshold D5b for the resistances of the bump-ball is referred to in step F12. In this example, in a case of exceeding 20 mOhm, it is determined that constraints of the package 10 is not satisfied.

The current loop area determination reference level D5c indicates a level of a size of the current loop area 10q of the package 10 in the constraint data D5. The current loop area determination reference level D5c is referred to in step F8. In this example, a level 2 is indicated. In a case in which the current loop area 10q exceeds the level 2, it is determined that the constraints of the package 10 are not satisfied. Levels will be described later.

Steps F2 and F3 are described with reference to FIG. 14A and FIG. 14B. FIG. 14A is a diagram for explaining the process at the side of the chip 2 in step F2. FIG. 14B is a diagram for explaining the process at the side of the package 10 in step F3.

In the process at the side of the chip 2 in step F2 in FIG. 12, the conversion part B2 generates the I/O allocation chart 2g by converting the I/O coordinates of the I/O assignment data D3. The I/O allocation chart 2g is displayed at the monitor 14a by the display part B4. The I/O allocation chart 2g is based on the package top view.

In FIG. 14A, an example of the I/O allocation chart 2g, which is converted from the I/O assignment data D3, is depicted. The I/O assignment data D3 indicates coordinates, the net name, and the like for each of the I/Os 9 of the chip 9, and includes items of “I/O NUMBER”, “X-COORDINATE”, “Y-COORDINATE”, “NET NAME”, and the like.

The item “I/O NUMBER” indicates a number uniquely given to each of the I/Os 9. By the I/O number, each of the I/Os 9 is specified. The item “X-COORDINATE” indicates a coordinate of a x-axis of the I/O 9 as the center of the chip 2 is set as an original point. The item “Y-COORDINATE” indicates a coordinate of a y-axis of the I/O 9 as the center of the chip 2 is set as an original point. The item “NET NAME” indicates the net name allocated to the I/O 9.

In this example, the I/O 9 of the I/O number “1” is located at the x-coordinate “−4000” and the y-coordinate “4000”, and corresponds to the net name “Sig11”. The I/O 9 of the I/O number “2” is located at the x-coordinate “−4000” and the y-coordinate “3900”, and corresponds to the net name “VSS11”. The I/O 9 of the I/O number “6” is located at the x-coordinate “−4000” and the y-coordinate “3500”, and corresponds to the net name “VDE11”.

In the I/O allocation chart 2g displayed at the monitor 14a, for each of the I/Os 9 deployed on the chip 2, the I/O type, which is allocated and correspond to the net name, is visible. That is, the I/O allocation chart 2g displays the I/O type to specify one of the power supply, the ground, and the signal which is allocated, for each of the I/Os 9.

In a process at the side of the package 10 in step F3 in FIG. 12, the display part B4 displays the ball allocation chart 10g based on the ball assignment data D4 at the monitor 14a. The ball allocation chart 10g is based on the package top view.

In FIG. 14B, an example of the ball allocation chart 10g based on the ball assignment data D4 is depicted. The ball allocation chart 10g may be data in a spread sheet format to represent an arrangement image of the balls 7 of the package 10.

A process in step F4 will be described with reference to FIG. 15A and FIG. 15B. FIG. 15A is a diagram for explaining a process at the side of the chip 2 in step F4. FIG. 15B is a diagram for explaining a process at the side of the package 10 in step F4.

At the process at the side of the chip 2 in step F4 in FIG. 12, the input part B3 generates the bump layout 2u in accordance with an instruction which includes the bump layout information D7 set by the designer and is received from the input device 15c. The bump layout 2u is displayed at the monitor 14a by the display part B4. The bump layout 2u is based on the package top view.

In FIG. 15A, the bump layout 2u, which is created based on the bump layout information D7, is illustrated. The bump layout information D7 indicates a rule to deploy the bumps 3. In this example, the bump layout information D7 defines that the bump pitch is 180 μm zigzag and an edge end portion rule is 150 μm.

In the process at the side of the package 10 in step F4 in FIG. 12, the input part B3 reads the bump layout 2u into the ball allocation chart 10g generated in step F3. The ball allocation chart 10g, into which the bump layout 2u is taken, is displayed at the monitor 14a by the display part B4. The ball allocation chart 10g is based on the package top view.

In FIG. 15B, an example of the ball allocation chart 10g, into which the bump layout 2u is taken, is depicted. The bump layout 2u is taken into a center portion of the ball allocation chart 10g.

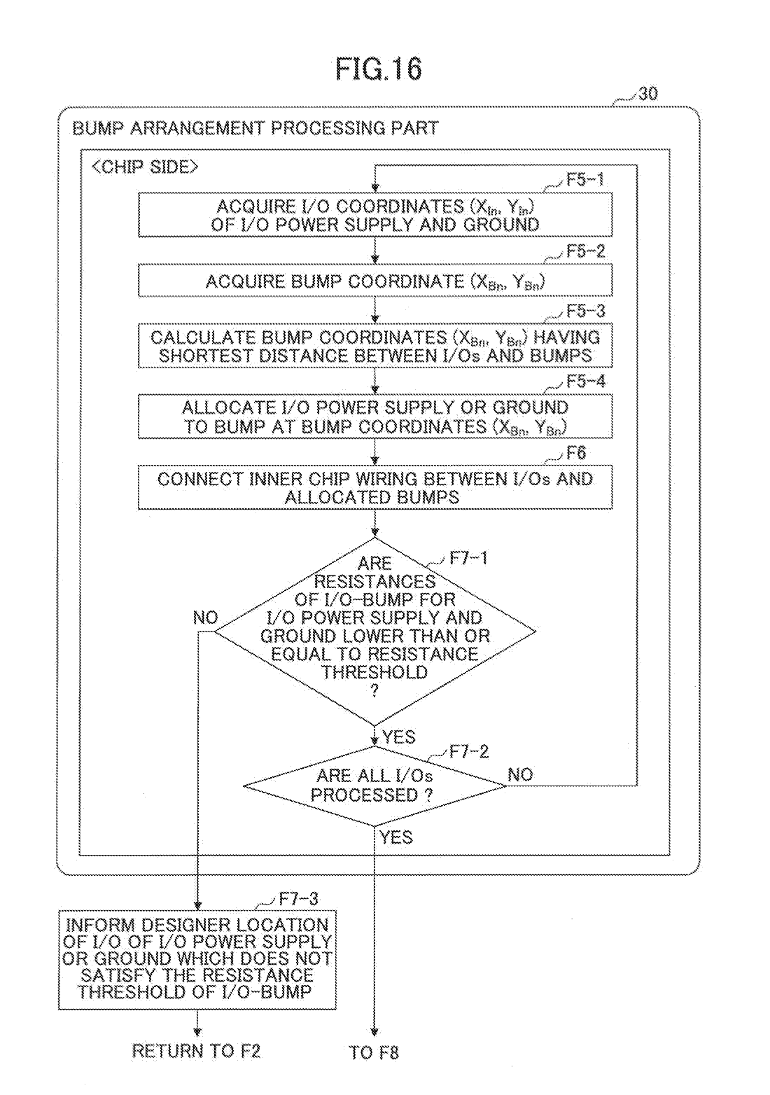

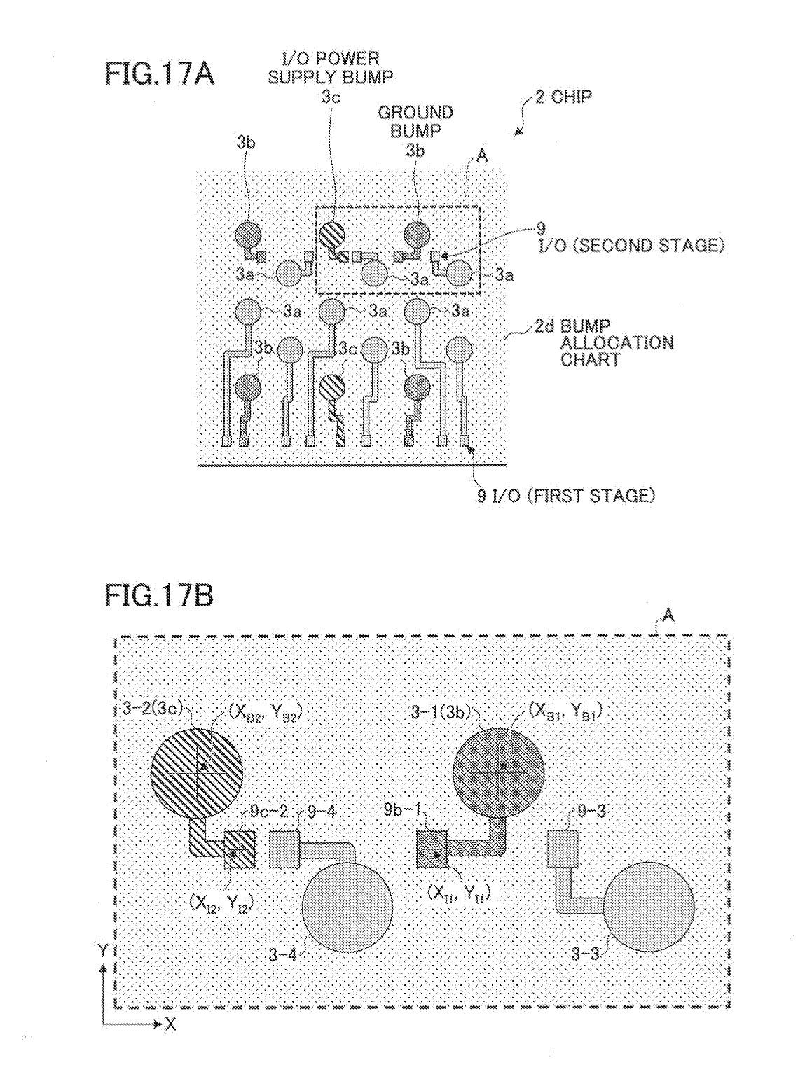

Processes in steps F5 to F7 are described with reference to FIG. 16 and FIG. 17. FIG. 16 is a flowchart for explaining a process at the side of the chip 2 in step F5. In FIG. 16, the specification part B5 acquires each set of the I/O coordinates (X_{In}, Y_{In}) with respect to the I/O power supplies and the grounds (step F5-1). Each set of the I/O coordinates converted in step F2 may be acquired. Also, the specification part B5 acquires the bump coordinates (X_{Bn}, Y_{Bn}) (step F5-2). Each set of the bump coordinates converted in step F3 may be acquired.

After that, the specification part B5 calculates the bump coordinates (X_{Bn}, Y_{Bn}) having the shortest distance from the I/O 9 to the bump 3 (step F5-3). The distance between the I/O 9 and the bump 3 is acquired by

{square root over (((X_{Bn}−XIₙ)²+(Y_{Bn}−Y_{In})²))}.

The specification part B5 allocates the I/O power supply or the ground to the bumps 3 of the coordinates (X_{Bn}, Y_{Bn}) (step F5-4). Based on the I/O assignment data D3, the net name of the I/O 9 and the allocated bump 3 are associated with each other.

The specification part B5 connects the I/O 9 and the allocated bump 3 by the wiring inside the chip 2 (step F6), and determines whether the resistances between the I/Os 9 of the I/O power supplies and the grounds and the bumps 3 are lower than or equal to the resistance threshold D5a (step F7-1).

When the resistances are lower than or the equal to the resistance threshold D5a (YES of step F7-1), the specification part B5 determines whether all I/Os 9 are processed (step F7-2). When all I/Os 9 are not processed (NO of step F7-2), the specification part B5 goes back to step F5-1, and the above described process is repeated in the same manner. On the other hand, when all I/Os 9 are processed (YES of step F7-2), the specification part B5 advances to step F8.

On the other hand, when the resistances exceed the resistance threshold D5a (NO of step F7-1), the specification part B5 informs one or more locations of the I/Os 9 of the I/O power supplies and the grounds, of which the resistances between the I/Os 9 and the bumps 3 do not satisfy the resistance threshold D5a, to the developer (step F7-3). Information pertinent to the one or more locations of the I/Os 9 is displayed at the monitor 14a by the display part B4. After the I/O assignment is reviewed again by the developer, the above described process is conducted from step F2 by the conversion part B2.

Process result examples in steps F5 to F7 will be described with reference to FIG. 17A and FIG. 17B. The bump allocation chart 2d depicted in FIG. 17A corresponds to a result example in a part of the chip 2. FIG. 17B is a diagram enlarging a portion A of the bump allocation chart 2d.

Each of distances between the I/O coordinates of the I/Os 9 and the bump coordinates of the bumps 3 is calculated. In this example, the bump coordinates nearest to the I/O coordinates (X_{I1}, Y_{I1}) of the ground I/O 9b-1 are bump coordinates (X_{B1}, Y_{B1}). Hence, a bump 3-1 is allocated to the ground, and is connected to a ground I/O 9b-1. The bump 3-1 corresponds to the ground bump 3b.

Also, the bump coordinates nearest to the I/O coordinates (X_{I2}, Y_{I2}) of the ground I/O 9b-1 are bump coordinates (X_{B2}, Y_{B2}). Hence, a bump 3-2 is allocated to the ground, and is connected to an I/O 9b-2. The bump 3-2 corresponds to the I/O power supply bump 3c.

On the other hand, the bumps 3-3 and 3-4 are not the shortest distance with respect to any one of the ground I/O 9b-1 and the power supply I/O 9c-2. Hence, the bumps 3-3 and 3-4 are excluded.

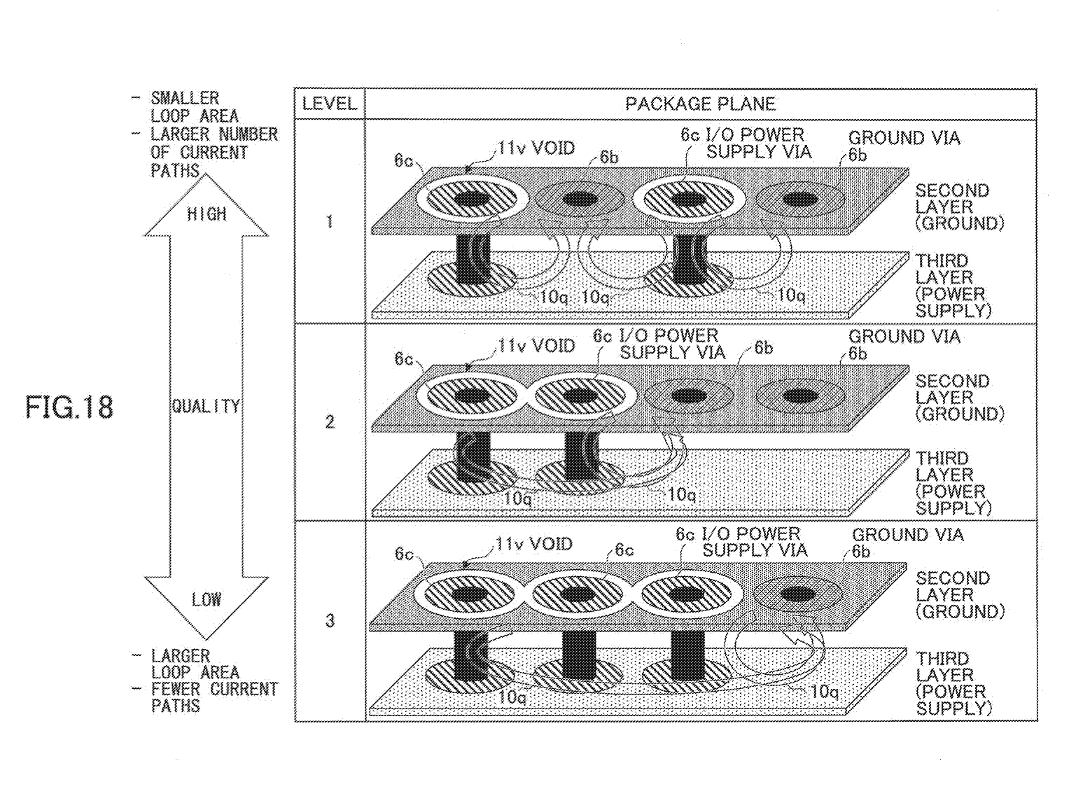

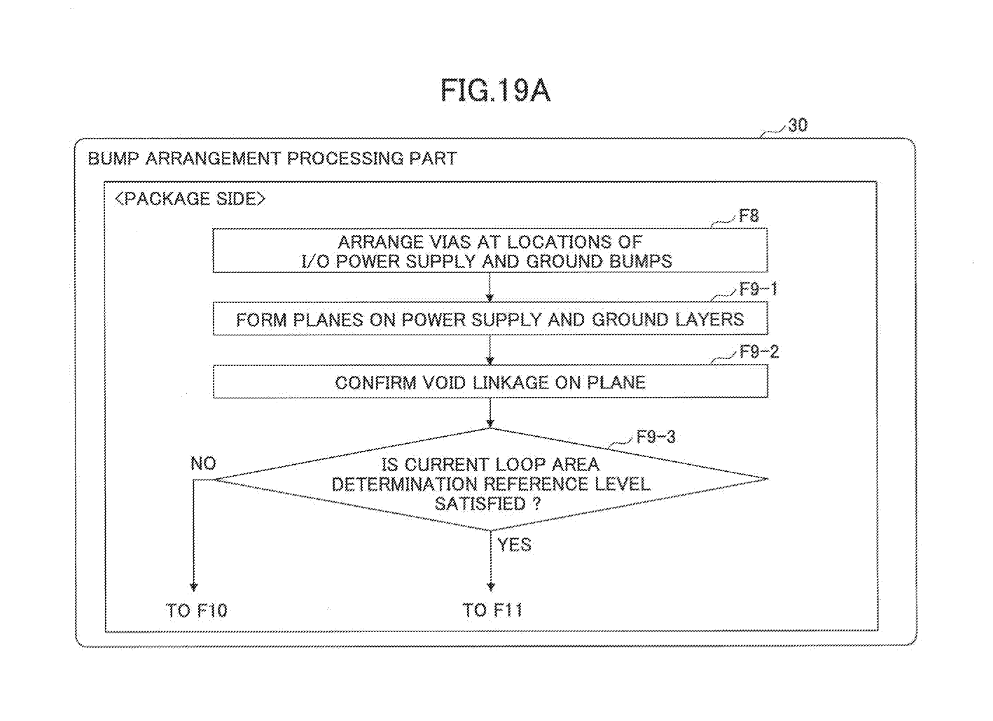

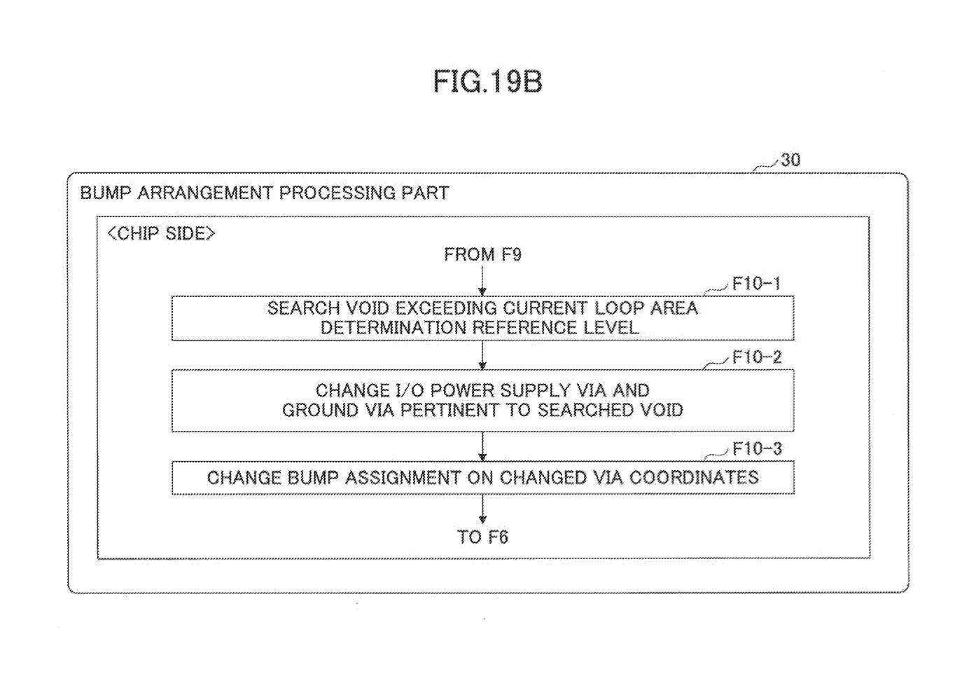

Processes in steps F8 to F10 will be described with reference to FIG. 18, FIG. 19A, and FIG. 19B. FIG. 18 is a diagram illustrating an example of the current loop area determination reference level. In FIG. 18, the example, in which the levels 1, 2, and 3 are set, is depicted. A level 4 or more may be set for the current loop area determination reference level D5c.

The level 1 corresponds to a state in which a void 11v includes one I/O power supply via 6c alone. The level 2 corresponds to a state in which the void 11v includes two I/O power supply vias 6c. The level 3 corresponds to a state in which the void 11v includes three I/O power supply vias 6c.

The fewer the I/O power supply vias 6 in the void 11v, the smaller becomes the current loop areas 10q. Accordingly, an inductance becomes less, noise is suppressed, and a quality of a package plane is improved. On the other hand, in a case in which a number of the I/O power supply vias 6c in the void 11v is greater, the current loop area 10q becomes larger, and current paths are reduced. Hence, the inductance becomes greater, the noise is increased, and the quality of the package plane is degraded.

The inventor focused on a relationship between the quality of the package plane depending on a dimension of the current loop area 10q and the number of the I/O power supply vias 6c included in the void 11v. Then, the inventor found out to determine the quality of the package plane based on the number of the power supply vias 6c in the void 11v.

In the semiconductor package 1 being increased in scale, load of an arithmetic processing is great for the current loop area 10q for each of the voids 11v. On the contrary, a load is significantly small for a determination process using the number of the power supply vias 6c in the void 11v.

The number of the power supply vias 6c in the void 11v is acquired by a simple process. As one example, by referring to the layout of the plane generated by deploying the vias 6, the number of the power supply vias 6c, which are deployed in an area of the void 11v, may be counted for each of the voids 11v. The number of the power supply vias 6c in the void 11v is simply counted.

The current loop area determination reference level D5c of the constraint data D5 indicates one of the above defined levels 1 to 3. By simply determining the level based on the number of the vias 6 in the void 11v, and determining whether the determined level satisfies the current loop area determination reference level D5c, it is possible to determine whether the quality of the package plane is satisfied.

If the void 11v is greater, it becomes difficult to wire the signal line (FIG. 5, FIG. 6, FIG. 7, FIG. 8A, and FIG. 8B). Hence, by reducing the size of the void 11v, that is, by reducing the number of vias 6 in the void 11v, it is possible to easily wire the signal line.

Accordingly, the inventor found out that the wiring of the signal line is improved by giving the current loop area determination reference level D5c. In the following, a process using the current loop area determination reference level D5c will be described.

FIG. 19A is a flowchart for explaining processes at the side of the package in steps F8 and F9. In FIG. 19A, the specification part B5 arranges the vias 6c and 6b at locations of the I/O power supply bumps 3 and the ground bumps 3b, respectively (step F8).

After that, the specification part B5 forms the planes on the power supply layer and the ground layer (step F9-1). In the example in FIG. 1, the planes are formed on the second layer (the ground layer) and the third layer (the power supply layer). The voids 11v are formed in response to a formation of the planes. The specification part B5 confirms a linkage concerning the voids 11v of the planes (step F9-2).

The specification part B5 determines whether the current loop area determination reference level D5c is satisfied (step F9-3). Based on the current loop area determination reference level D5c, it is determined by using the number of the vias 6 included in each of the void 11vs.

In a case in which the current loop area determination reference level D5c indicates the level 2 in FIG. 18, if the formed planes correspond to the level 1 or the level 2, the specification part B5 determines that the current loop area determination reference level D5c is satisfied. If the formed planes correspond to the level 3, the specification part B5 determines that the current loop area determination reference level D5c is satisfied.

In a case of in which the current loop area determination reference level D5c indicates the level 1 in FIG. 18, if the formed planes correspond to the level 1, the specification part B5 determines that the current loop area determination reference level D5c is satisfied. If the formed planes correspond to the level 2 or the level 3, the specification part B5 determines that the current loop area determination reference level D5c is not satisfied.

When the current loop area determination reference level D5c is not satisfied (NO of step F9-3), the specification part B5 advances to step F10 (FIG. 19B). On the other hand, when the current loop area determination reference level D5c is satisfied (YES of step F9-3), the specification part B5 advances to step F11 (FIG. 12).

FIG. 19B is a flowchart for explaining a process at the side of the chip 2 in step F10. In FIG. 19B, the specification part B5 refers to the plane of the second layer, and searches for the void 11v exceeding the current loop area determination reference level D5c (step F10-1). If the current loop area determination reference level D5c indicates the level 2, the voids 11v correspond to the level 3 are searched for.

The specification part B5 changes the I/O power supply vies 6c and the void vias 6b related to the searched voids 11v (step F10-2). By changing the vias 6 inside the voids 11v and on the periphery of the voids 11v, the number of the I/O power supply vias 6c being adjacent is reduced.

Preferably, the vias 6 inside the voids 11v and on the periphery of the voids 11v are changed so as to alternately deploy the I/O power supply vias 6c and the void vias 6b inside the voids 11v. In a case of the voids 11v corresponding to the level 3, the vias 6 inside the voids 11v and on the periphery of the voids 11v are changed so as to satisfy at least the level 2. Hence, the number of the I/O power supply vias 6c being adjacent is reduced.

In order for the searched voids 11v to satisfy the current loop area determination reference level D5c, the I/O power supply vias 6c inside the searched voids 11v and the ground vias 6b on the periphery of the searched voids 11v are changed. As a result, the number of the I/O power supply vias 6c inside the searched voids 11v is reduced. In a case in which one or more searched voids 11v include three I/O power supply vias 6c, the number of the I/O power supply vias 6c in the one or more searched voids 11v is reduced to two or one by changing the I/O power supply vias 6c and the ground vias 6b. That is, in a case in which the searched voids 11v correspond to the level 3, the I/O power supply vias 6c and the ground vias 6b are changed in order for the searched voids 11v to correspond to the level 2 or the level 1.

After that, the specification part B5 changes the bump assignment on a changed via coordinates (step F10-3). By conducting steps F10-1 to F10-3, the voids 11v become smaller. Then, the I/O power supply vias 6c and the ground vias 6b are deployed closer at the level 1. That is, the I/O power supply vias 6c and the ground vias 6b are alternately deployed.

As described above, in the embodiment, instead of calculating the size of the current loop areas 10q, the above described simple process is conducted in which the number of the I/O power supply vias 6c in each of the voids 11v is determined. Accordingly, compared with a calculation of the current loop areas 10q, it is possible to improve a process effectiveness.

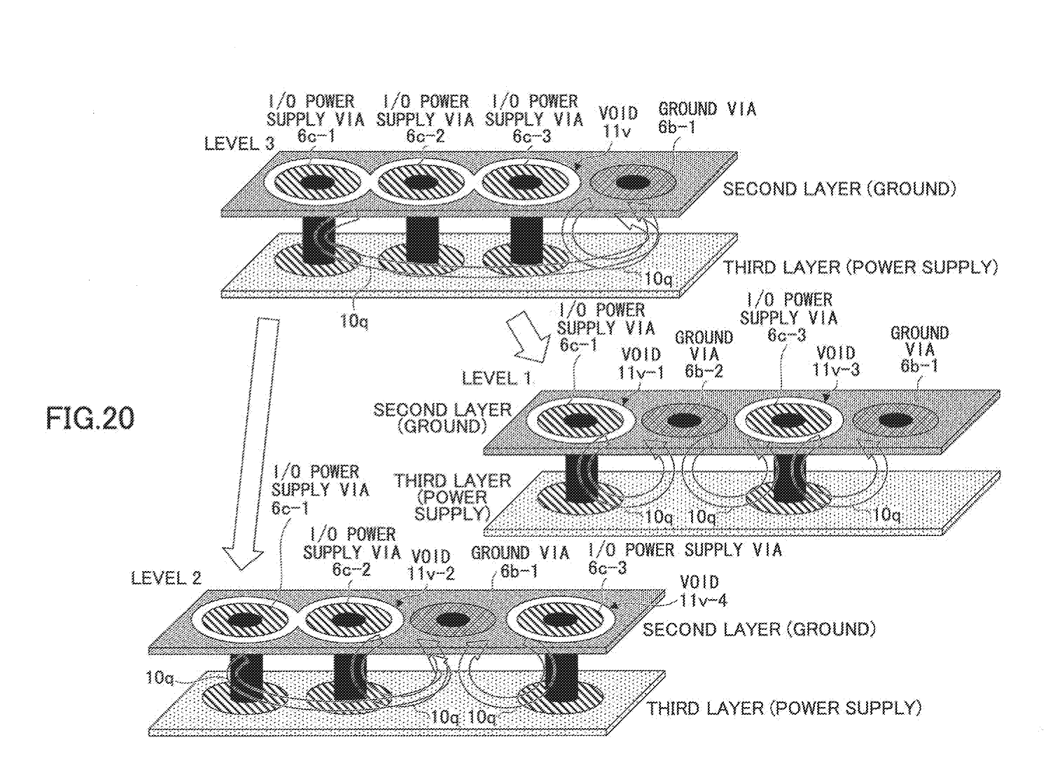

FIG. 20 is a diagram illustrating an example of a level improvement. In FIG. 20, a case will be described in which the void 11v formed as three balls being chained is searched for in step F10-1. Also, the current loop area determination reference level D5c indicates the level 2.

A ground via 6b-1 on the periphery of the void 11v is replaced with an I/O power supply via 6c-3 inside the void 11v. The void 11v is reduced to a void 11v-2 shaped like eyeglasses. Accordingly, the level 3 is improved to the level 2.

Alternatively, a ground via 6b-2 on the periphery of the void 11v is replaced with an I/O power supply via 6c-2 inside the void 11v. Instead of the void 11v, a void 11v-2 and a void 11v-3 are formed. The void 11v-2 includes one I/O power supply via 6c-1 alone. Similarly, the void 11v-4 includes one I/O power supply via 6c-3 alone. Accordingly, the level 3 is improved to the level 1.

By a re-allocation of the bumps 3 in response to the above described replacement, it is possible to retain the quality of a predetermined package plane. Also, it is possible to improve the wiring of the signal line by the replacement.

A difference between a first bump assignment and a second bump assignment will be described by comparison examples below. In the first bump assignment, the current loop areas 10q is not considered. Contrary, in the second bump assignment, the current loop areas 10q is considered.

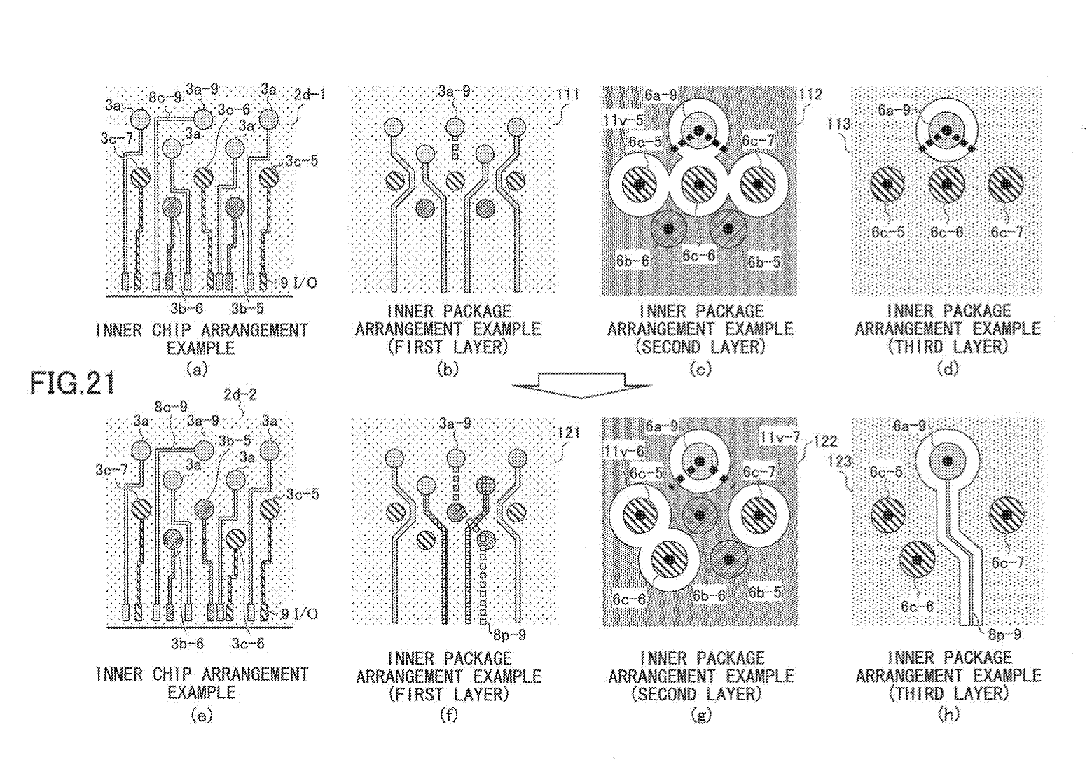

FIG. 21 is a diagram illustrating the comparison examples between the first and second bump assignments. In FIG. 21, an upper side corresponds to the core side, and a lower side corresponds to the scribe side. Only the part of the chip 2 and a part of each of the planes of the package 10 are depicted. The signal bump 3a, a signal bump 3a-9, ground bumps 3b-5 to 3b-6, and the I/O power supply bumps 3c-5 to 3c-7 may be collectively called the bumps 3. Also, the signal via 6a-9, the ground vias 6b-5 and 6b-6, and the I/O power supply bias 6c-5 to 6c-7 may be collectively called the vias 6.

FIG. 21(a), FIG. 21(b), FIG. 21(c), and FIG. 21(d) depict result examples of the first bump assignment in which the current loop areas 10q is not considered. FIG. 21(e), FIG. 21(f), FIG. 21(g), and FIG. 21(h) depict result examples of the second bump assignment in which the current loop areas 10q is considered.

In a bump allocation chart 2d-1 in FIG. 21(a), a wiring example of the inside of the chip 2 in initial steps F5 and F6 at the side of the chip 2 is depicted. The I/O power supply bumps 3c-8 and 3c-7 are allocated closer to the I/Os 9 of the I/O power supplies. Moreover, the ground bumps 3b-5, 3b-6, and 3b-7 are allocated. Furthermore, the signal bumps 3a and 3a-9 are allocated.

FIG. 21(b), FIG. 21(c), and FIG. 21(d) depict wiring examples of planes 111, 112, and 113, which are conducted based on the bump allocation chart 2d-1. The planes 111, 112, and 113 correspond to the first layer, the second layer, and the third layer, respectively.

FIG. 21(b) depicts the plane 111 representing wirings inside the package 10. The wirings depicted in FIG. 21(b) correspond to the bump allocation chart 2d-1 of the chip 2. Wirings toward the signal via 6a-9 (FIG. 21(c)) corresponding to the signal bump 3a-9, which are not conducted on the first layer, are illustrated by the dashed lines. Each of these wirings is attempted on the second layer.

As illustrated in FIG. 21(c), on the plane 112 at the second layer, the I/O power supply vias 6c-5 to 6c-7 are adjacently deployed on a line. Hence, a void 11v-5 is formed in a shape chaining three voids respective to the I/O power supply vias 6c-5 to 6c-7. The void 11v-5 is formed closer to the scribe side than the signal bump 3a-9. Any of the wirings toward the signal via 6a-9 corresponding to the signal bump 3a-9 is not conducted even on the second layer of the package 10. Thus, the wirings are depicted by the dashed lines. Furthermore, each of these wirings is attempted on the third layer.

As illustrated in FIG. 21(d), even on the third layer, any of the wirings toward the signal via 6a-9 is not conducted due to the I/O power supply vias 6c-5 to 6c-7. The wirings toward the signal via 6a-9, which are not conducted on the third layer of the package 10, are depicted by the dashed lines. In this case, designs of the I/O assignment data D3, ball assignment data D4, and the like are reviewed by the designer. Excess process loads are occurred such as extra reviews of these designs.

The second bump assignment in the embodiment in which the current loop areas 10q is considered. In the embodiment, at a via arrangement on the second layer in FIG. 21(c), the current loop areas 10q of the void 11v-5 is considered. By a simplified process using the current loop area determination reference level D5c and the number of vias 6 included in the void 11v-5, the current loop areas 10q are considered (step F9).

The void 11v-5 includes the vias 6c-5, 6c-6, and 6c-7. Thus, the number of vias 6 is three, and the void 11v-5 corresponds to the level 3.

If the current loop area determination reference level D5c indicates the level 2 (FIG. 18), the level of the void 11v-5 is improved by replacing the I/O power supply via 6c-6 with the ground via 6b-5 or 6b-6. In step F10-2, the I/O power supply via 6c-6 is replaced with the ground via 6b-6.

In response to a change by this replacement, in step F10-3, assignments of the bumps 3 on the I/O power supply via 6c-6 and the ground via 6b-6 are changed.

FIG. 21(e) illustrates a bump allocation chart 2d-2 after the bump assignment is changed. Compared with the bump allocation chart 2d-1 in FIG. 21(a), the I/O power supply bump 3c-6 is replaced with the ground bump 3b-5. A bump replacement of the chip 2 corresponds to a via replacement of the package 10. In response to the bump replacement, a wiring connection is conducted between the replaced bumps 3 and the I/Os 9.

FIG. 21(f) indicates a plane 121 of the package 10 based on the bump allocation chart 2d-2. On the first layer of the package 10, the ground bump 3b-5 and the I/O power supply bumps 3c-5 to 3c-7 at the side of the chip 2 become walls. Thus, the wiring is not conducted toward the scribe side for the signal bump 3a-9. An inner package wiring 8p-9 for the signal bump 3a-9, which is not conducted on the first layer, is depicted by the dashed line to represent a wiring conducted on another layer. The wiring is attempted on the second layer.

As illustrated in FIG. 21(g), a plane 122 deploying the vias 6a-9, 6b-5, 6b-6, 6c-5 to 6c-7 is generated. A wiring toward the signal via 6a-9 of the signal bump 3a-9 is not conducted due to voids 11v-6 and 11v-7 and the ground via 6b-6.

However, different from the plane 112 in FIG. 21(c), the voids 11v-6 and 11v-7, which are formed on the plane 122 of the second layer where the vias 6a-9, 6b-5, 6b-6, 6c-5 to 6c-7 are deployed, satisfy the current loop area determination reference level D5c.

By a determination based on the current loop area determination reference level D5c, as depicted in FIG. 21(h), the signal bump 3a-9 is connected through the via 6a-9 on the third layer of the package 10. In a plane 123, an inner package wiring 8p-9 is conducted.

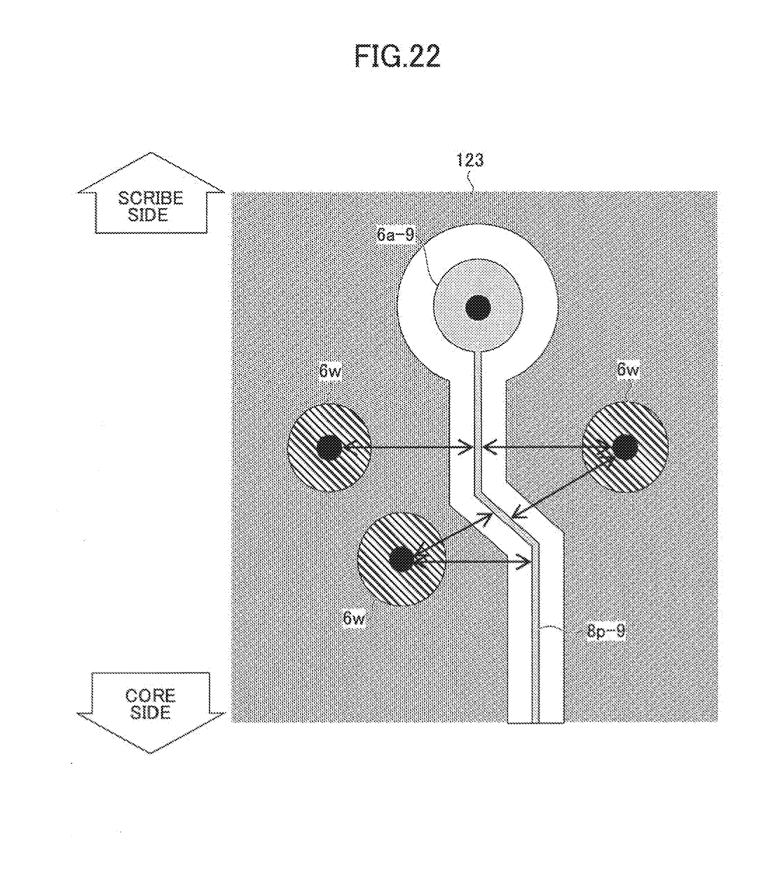

On the plane 123, the inner package wiring 8p-9 may be arranged as illustrated in FIG. 22. FIG. 22 is a diagram for explaining an arrangement method of the inner package wiring 8p-9. In FIG. 22, the inner package wiring 8p-9 may be arranged based on a certain reference with space to power supplies 6w. A certain reference may be given by the constraint data D5.

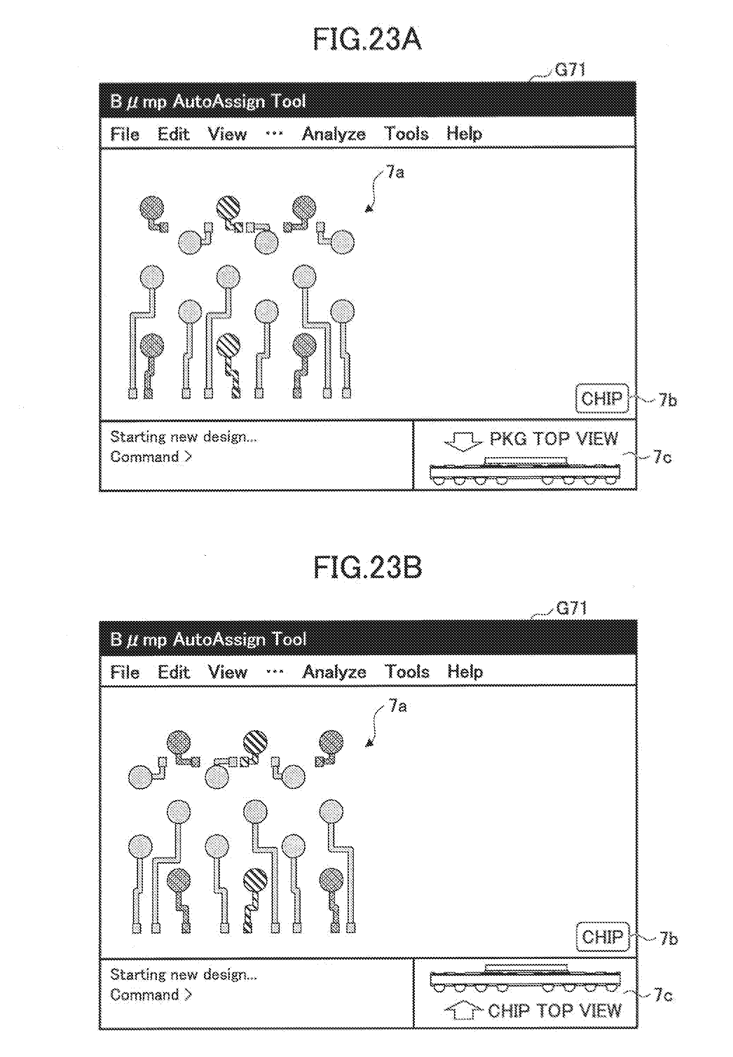

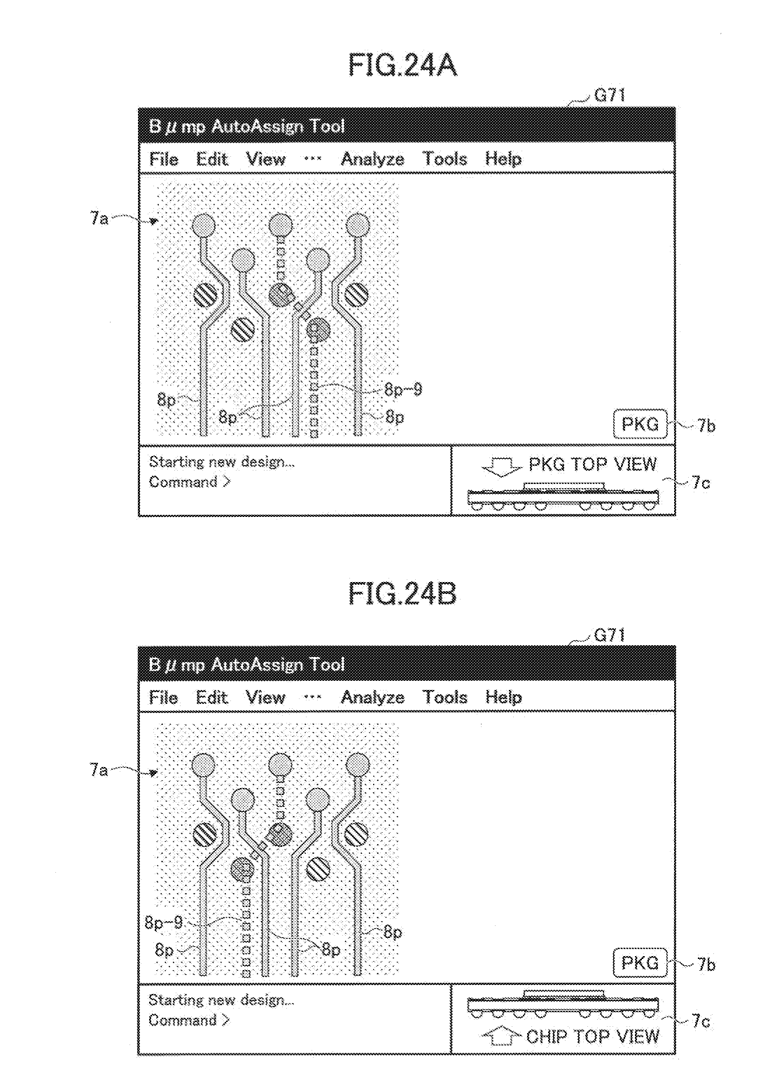

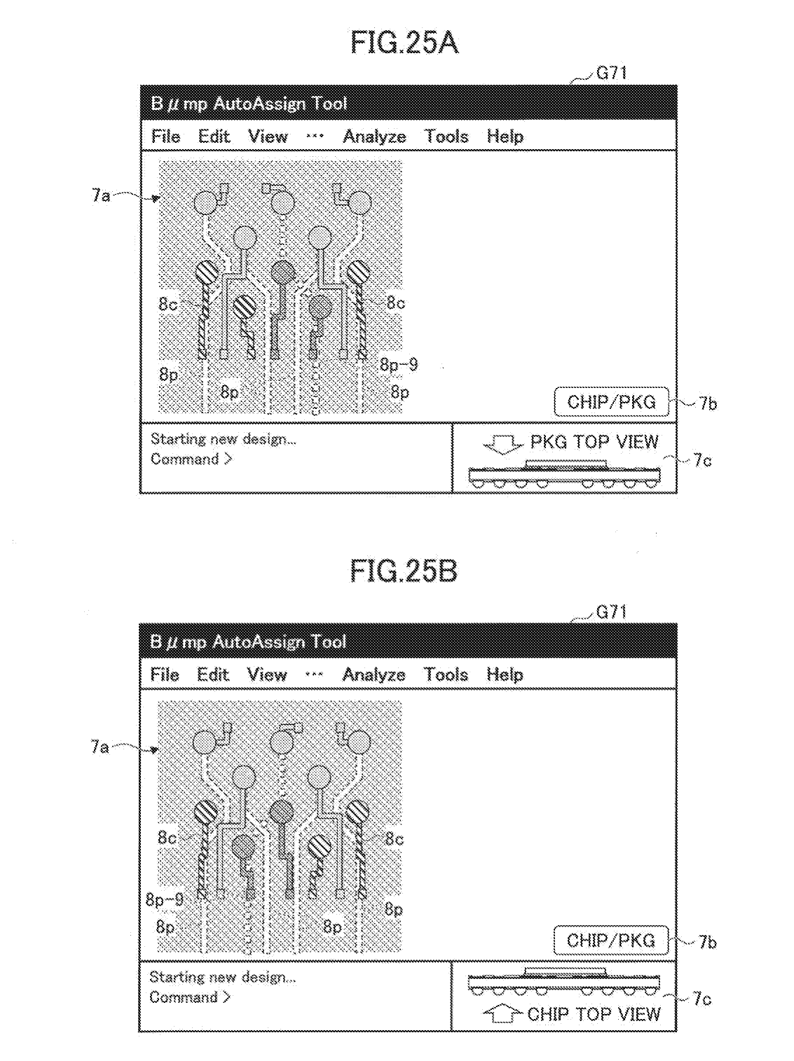

In the following, layout display examples pertaining to the bump assignment will be described with reference to FIG. 23A, FIG. 23B, FIG. 24A, FIG. 24B, FIG. 25A, and FIG. 25B.

Layout display examples of the chip 2 will be described with reference to FIG. 23A and FIG. 23B. FIG. 23A illustrates a screen G71 displaying an layout at the package top view. The screen G71 includes an assignment result display area 7a, an subject display area 7b, a direction display area 7c, and the like.

The assignment result display area 7a is regarded as an area which displays an assignment result at the side of the chip 2 or the package 10.

The subject display area 7b is regarded as an area in which a subject being displayed is the chip 2 alone, the package 10 alone, or an overlap of the chip 2 and the package 10. The subject display area 7b indicates “CHIP” when the subject is the chip 2, “PKG” when the subject is the package 10, and “CHIP/PKG” for an overlap display. The designer clicks the subject display area 7b by using the mouse 15b or the like to change the subject being displayed.

The view direction display area 7c indicates is regarded as an area which indicates a display at the package top view or a display at the chip top view. When the view direction display area 7c is clicked by the mouse 15b or the like, a display of the assignment result display area 7a is changed from the package top view to the chip top view.

When the designer clicks the view direction display area 7c in the screen G71 illustrated in FIG. 23A, as illustrated in FIG. 23B, the assignment result display area 7a in the screen G71 displays the layout of the chip 2 at the chip top view. When the designer clicks the view direction display area 7c again, as illustrated in FIG. 23A, the screen G71 is displayed. For an initial display, the package top view is applied as a default setting.

The designer of the chip 2 confirms the layout at the package top view illustrated in FIG. 23A. When the designer of the chip 2 reviews the layout of the chip 2 with a designer of the package 10, the layout may be displayed the chip top view illustrated in FIG. 23B. By clicking the view direction display area 7c, it is free to change from the chip top view (FIG. 23B) to the package top view (FIG. 23A). In the following display examples, a view is switched by operating the view direction display area 7c in the same manner.

In FIG. 23A and FIG. 23B, bump types for identifying the I/O power supply, the ground, the signal, and the like are distinguishably displayed. It is possible to switch the subject to the package 10 in response to a click on the subject display area 7b in the screen G71.

Next, layout display examples of the package 10 will be described.

The layout display examples of the package 10 will be described with reference to FIG. 24A and FIG. 24B. FIG. 24A illustrates the screen G71 displaying the layout of the package 10 at the package top view.

As illustrated in FIG. 24A, the layout of the plane of the first layer of the package 10 in the assignment result display area 7a in the screen G71 is displayed.

The subject display area 7b indicates that the subject is the package 10. Also, in the layout example in FIG. 24A, the view direction display area 7c indicates that the layout of the package 10 is displayed at the package top view in the assignment result display area 7a.

A case, in which the chip top view is selected by clicking the view direction display area 7c, is illustrated in FIG. 24B. In FIG. 24B, the layout of the package 10 on the plane of the first layer is displayed at the chip top view in the assignment result display area 7a.

In FIG. 24A and FIG. 24B, based on the layout of the chip 2, the bump types for identifying the I/O power supply, the ground, the signal, and the like are distinguishably displayed. The inner package wirings 8p, which are arranged and wired on the first layer, are depicted by solid lines, and the inner package wiring 8p-9, which is arranged on another layer, is depicted by the dashed line.

Moreover, by clicking the subject display area 7b in the screen G71, it is possible to switch the subject to the overlap. A display example of the overlap display will be described.

Layout display examples of the overlap will be described with reference to FIG. 25A and FIG. 25B. FIG. 25A illustrates the screen G71 which overlays and displays the layout of the chip 2 and the layout of the package 10 at the package top view in the assignment result display area 7a.

As illustrated in FIG. 25A, the layout of the chip 2 and the layout of the package 10 are overlaid and displayed at the package top view in the assignment result display area 7a of the screen G71.

The subject display area 7b indicates that the subject is the overlay. Also, in the layout display example in FIG. 25A, the view direction display area 7c indicates the overlay display at the package top view.

FIG. 25B illustrates a case in which the chip top view is selected by clicking the view direction display area 7c. In FIG. 25B, the screen G71 is depicted in a state of overlaying and displaying the layout of the chip 2 and the layout of the package 10 at the chip top view in the assignment result display area 7a.

As illustrated in FIG. 25B, the layout of the package 10 is displayed as the plane of the first layer. The inner package wirings 8p, which are arranged and wired on the first layer, are depicted by solid lines, and the inner package wiring 8p-9, which is arranged on another layer, is depicted by the dashed line.

The subject display area 7b indicates that the subject is the overlay. Also, in the layout display example in FIG. 25B, the view direction display area 7c indicates the overlay display at the chip top view.

In FIG. 25A and FIG. 25B, based on the layout of the chip 2, the bump types for identifying the I/O power supply, the ground, the signal, and the like are distinguishably displayed. The inner package wirings 8p, which are arranged and wired on the first layer, are depicted by solid lines, and the inner package wiring 8p-9, which is arranged on another layer, is depicted by the dashed line.

Also, at both the sides of the chip 2 and the package 10, the I/Os 9, the I/O power supply bumps 3c, the inner chip wiring 8c, and the inner package wirings 8p for the I/O power supplies are displayed with the same color (which may be red). Moreover, for the same color portions, different hatchings may be applied between the chip 2 and the package 10. Alternatively, between the chip 2 and the package 10, similar but slightly different colors (which may be red and pink colors or the like) may be used to display respective layouts. In addition, different hatchings may be applied.

That is, it is preferable for portions pertinent to the I/O power supplies to be distinguishably displayed from other portions related to the grounds, the signals and the like, and is also preferable for the wirings to be distinguishably displayed between the sides of the chip 2 and the package 10. The inner chip wirings 8c and the inner package wirings 8p may be represented by the same color with the different hatchings. Thus, it is possible to improve visibility of the wirings.

In FIG. 23A, FIG. 23B, FIG. 24A, FIG. 24B, FIG. 25A, and FIG. 25B, in response to the subject display area 7b, in a case of displaying the arrangement of the signal lines, the arrangement of the signal lines may be displayed at the same view state as is selected. In detail, when the subject is changed from the chip 2 to the package 10 at the chip top view, the arrangement of the signal lines may be displayed at the chip top view.

Alternatively, as the package top view is a default view, the arrangement of the signal lines may be displayed at the default view at each time the subject is switched. When the subject is changed to the chip 2 or the overlay, the arrangement of the signal lines may be displayed in the same manner.

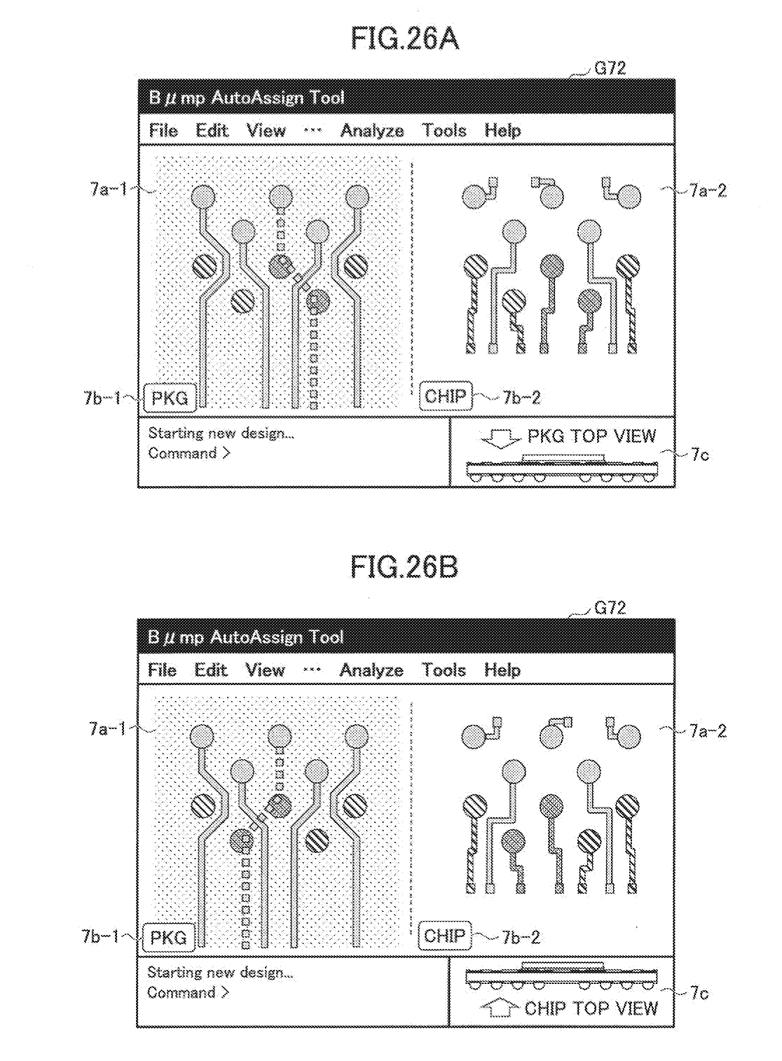

Other than the above described display examples, the layout of the chip 2 and the layout of the package 10 are displayed in parallel. Other display examples will be described with reference to FIG. 26A and FIG. 26B. FIG. 26A illustrates a screen G72 which displays the layout of the chip 2 and the layout of the package 10 in parallel at the package top view.

Different from the screen G71, the screen G72 includes an assignment result display area 7a-1, an assignment result display area 7a-2, and the like. The screen G72 further includes a subject display area 7b-1 at a side of the assignment result display area 7a-1 and the a subject display area 7b-2 at a side of the assignment result display area 7a-2. The view direction display area 7c is the same as that in the screen G71.

In the assignment result display area 7a-1, the layout of the plane of the first layer of the package 10 is displayed at the package top view, and the subject display area 7b-1 indicates the display of the package 10. Also, the layout of the chip 2 is displayed at the package top view in the assignment result display area 7a-2, and the subject display area 7b-2 indicates the display of the chip 2.

It is possible for the designer to switch from the package top view to the chip top view by clicking the view direction display area 7c.

FIG. 26B illustrates the screen G72 which displays the layout of the chip 2 and the layout of the package 10 in parallel at the chip top view. As illustrated in FIG. 26B, the layout of the plane of the first layer of the package 10 is displayed at the chip top view in the assignment result display area 7a-1, and the subject display area 7b-1 indicates the display of the package 10. Also, the layout of the chip 2 is displayed at the chip top view in the assignment result display area 7a-2, and the subject display area 7b-2 indicates the display of the chip 2.

In FIG. 26A and FIG. 26B, in a case in which a display area is scrolled to one of the subject display area 7b-1 or the subject display area 7b-2, another display area at another subject display area 7b-1 or 7b-2 is scrolled in response to the scroll of the one area.

In the above described layout display examples in FIG. 23A to FIG. 26B, examples of displaying the plane of the first layer of the package 10 are given. However, the layout of the plane may be depicted at any other layer: the second layer, the third layer, . . . . The layer to display may be selected by the designer. Moreover, different colors and hatchings may be applied to distinguish the I/O power supplies, the grounds, the signal lines, the voids, and the like.

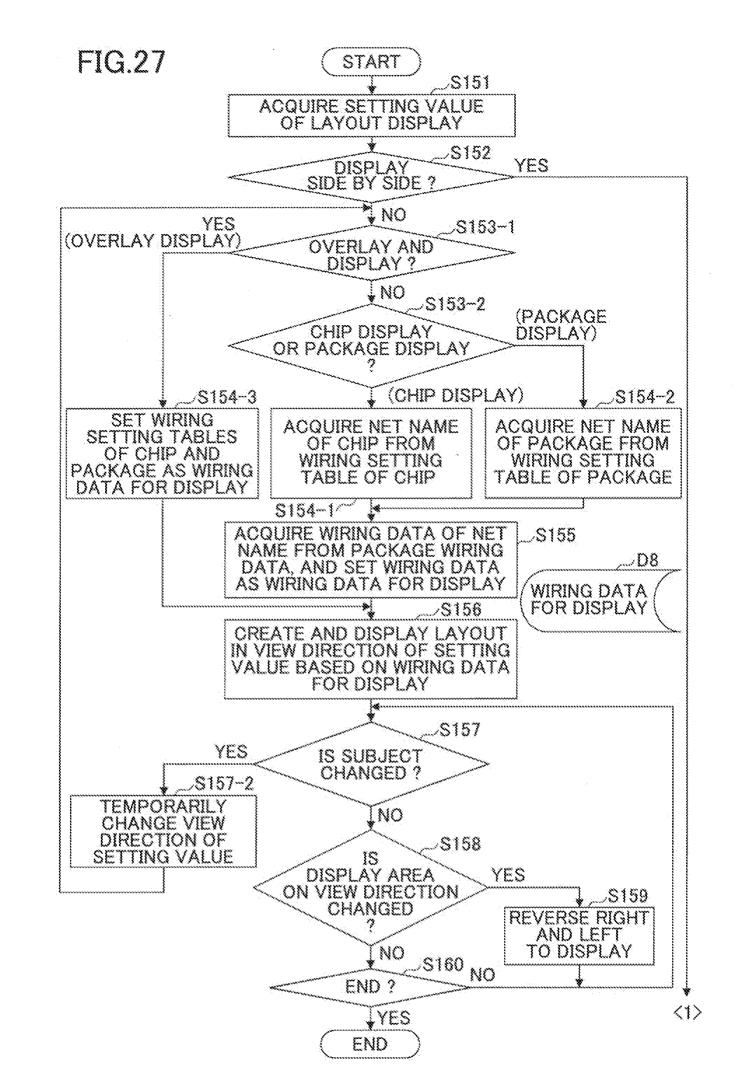

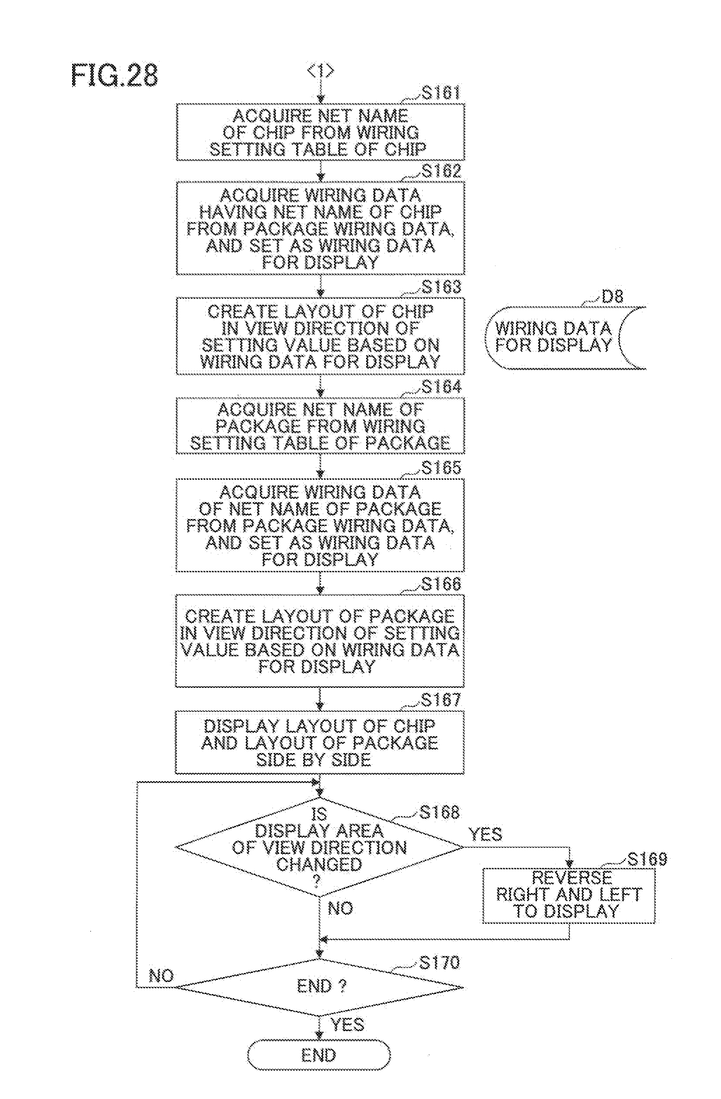

The above described various layout displays are conducted by the display part B4. A layout display process will be described with reference to FIG. 27 and FIG. 28. FIG. 27 and FIG. 28 are diagrams for explaining the layout display process.

In FIG. 27, when receiving a request of the layout display from the input device 15c, the display part B4 acquires a setting value of the layout display (step S151). At the layout display, the setting value may indicate a default setting such as a display method set as an initial setting of the EDA tool 300 or set by the designer for an initial display.

By the setting value, at least a display format and a view direction may be specified. For example, the display format and the view direction may be indicated by “chip display; package top view”, “package display; chip top view”, “overlay display; chip top view”, “parallel display”, or the like.

The display part B4 determines whether “parallel display” for displaying both the layouts of chip 2 and the package 10 side by side is indicated as the display format by the setting value (step S152). When the “parallel display” is indicated as the display format (YES of step S152), the display part B4 advances to step S161 (FIG. 28).

On the other hand, when the “parallel display” is not indicated as the display format (NO of step S152), the display part B4 further determines whether “overlay display” is indicated as the display format (step S153-1).

When “overlay display” is not indicated as the display format (NO of step S153-1), the display part B4 determines whether “chip display” or “package display” is indicated (step S153-2).

When “chip display” is indicated as the display format, the display part B4 acquires the net name of the chip 2 from the wiring setting table D2a of the chip 2 (step S154-1). When “package display” is indicated as the display format, the display part B4 acquires the net name of the package 10 from the wiring setting table D2b (step S154-2).

On the other hand, after step S154-1 when “chip display” is indicated or after step S155 when “package display” is indicated as the display format, the display part B4 acquires wiring data having the acquired net name, from the package wiring data D9, and sets the wiring data as wiring data D8 for a display (step S155). After that, the display part B4 advances to step S156.

When “overlay display” is indicated as the display format (YES of step S153-1), the display part B4 sets the wiring setting table D2 as the wiring data D8 for the display (step S154-3), and advances to step S156.

The above described steps S153-1 and S153-2 are not limited to a determination order of “overlay display”, “chip display”, and “package display”.

The display part B4 creates and displays one or both the layouts of the chip 2 and the package 10 in the view direction indicated by the setting value (step S156).

After that, the display part B4 determines whether the subject is changed (step S157). The display part B4 detects a click operation informed from the input device 15c, and determines whether the designer changes the subject by clicking the subject display area 7b of the screen G71. When the subject is changed (YES of step S157), the display part B4 temporarily changes the view direction indicated by the setting value (step S157-2), and advances to step S153-1.

When the subject is not changed (NO of step S157), the display part B4 determines whether the view direction is changed (step S158). The display part B4 determines whether the designer changes the view direction by clicking the view direction display area 7c of the screen G71.

When the view direction is changed (YES of step S158), the display part B4 reverses right and left of the layout being displayed in the assignment result display area 7a (step S159). After that, the display part B4 goes back to step S157 in order to detect a next operation of the developer.

On the other hand, when the view direction is not changed (NO of step S158), the display part B4 determines whether the layout display is ended (step S160). When the layout display is not ended (NO of step S160), the display part B4 goes back to step S157 in order to detect the next operation of the developer.

On the other hand, when the layout display is ended (YES of step S160), the display part B4 terminates the layout display process. The display format and the view direction indicated by the setting value are reset to the default in response to the end of the layout display.

In FIG. 28, the display part B4 acquires the net name of the chip 2 from the wiring setting table D2a of the chip 2 (step S161).

The display part B4 acquires the wiring data of the net name, from the package wiring data D9, and sets the acquired wiring data as the wiring data D8 for the display (step S162). After that, based on the wiring data D8 for the display, the layout of the chip 2 is created in the view direction indicated by the setting value (step S163).

After that, the display part B4 acquires the net name of the package 10 from the wiring setting table D2b of the package 10 (step S164).

The display part B4 acquires the wiring data of the net name, from the package wiring data D9, and sets the acquired wiring data as the wiring data D8 for the display (step S165). After that, based on the wiring data D8 for the display, the display part B4 creates the layout of the package 10 in the view direction indicated by the setting value (step S166).

The display part B4 displays the layout of the chip 2 and the layout of the package 10 side by side (step S167).

After that, the display part B4 determines whether the view direction is changed (step S168). The display part B4 determines whether the designer changes the view direction by clicking the view direction display area 7c of the screen G71.

When the view direction is changed (YES of step S168), the display part B4 displays the layout by reversing the right and left of the layout being displayed in the assignment result display area 7a (step S169). The display part B4 advances step S170.

On the other hand, when the view direction is not changed (NO of step S168), the display part B4 determines whether the layout display is ended (step S170). When the layout display is not ended (NO of step S170), the display part B4 goes back to step S168 in order to detect the next operation of the designer.

On the other hand, when the layout display is ended (YES of step S170), the display part B4 ends the layout display process. The view direction of the setting value is reset to the default in response to the end of the layout display.

In the embodiment, the inner chip wirings 8c and the inner package wirings 8p are substantially simultaneously conducted by the single EDA tool 300. In the bump assignment (as an example, the area bump assignment), it is possible to design the semiconductor device in which the resistances of the I/Os 9 for the power supplies are suppressed to be lower.

Also, in the embodiment, a quality due to the current loop area 10q based on the via arrangement is determined by the number of vias 6 in each of the voids 11v. Accordingly, it is possible to improve the process effectiveness. Even in a case in which it is difficult to wire the signal lines, it is possible to enable the wirings of the signal lines with quality improvement by adjusting the bump assignments.

Moreover, in the embodiment, the single EDA tool 300 switches to the inner chip wirings 8c (that is, the layout of the chip 2) or the inner package wirings 8p (that is, the layout of the package 10). Also, the single EDA tool 300 may alternatively display both the inner chip wirings 8c and the inner package wirings 8p.

Accordingly, it is possible for both the developers of the chip 2 and the package 10 to easily conduct the layouts at both sides of the chip 2 and the package 10. As described above, in the embodiment, it is possible to conduct a display suitable for a substantially simultaneous review of the bump assignments on both sides of the chip 2 and the package 10.

According to the embodiment, it is possible to effectively realize the area bump assignment in consideration of the inner chip wirings 8c and the inner package wirings 8p, and to design the semiconductor device in which the power supply wiring resistance of I/O sections is suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A semiconductor design method performed in a computer, the method comprising:
assigning, by the computer, bumps to multiple Input and Output (I/O) sections of a chip;
arranging, by the computer, a plane by deploying vias at locations of the bumps which are allocated to I/O sections of power supplies and grounds, with respect to a package on which the chip is mounted; and
changing, by the computer, an allocation of the bumps with respect to the I/O sections of the power supplies and the grounds among the multiple I/O sections based on a number of the vias inside a void formed on the plane.

2. The semiconductor design method as claimed in claim 1, further comprising:
determining, by the computer, whether quality of the package is satisfied, by referring to at least one reference level in which a reference of a current loop area is given by a reference number of the vias inside the void; and
reducing, by the computer, a number of the vias of the power supplies adjacent inside the void, by changing an arrangement of the vias inside the void and around the void, when the number of the vias inside the void is unable to satisfy the reference level.

3. The semiconductor design method as claimed in claim 2, further comprising:
changing the allocation of the bumps to alternately deploy the vias of the power supplies and the grounds.

4. The semiconductor design method as claimed in claim 3, further comprising:
changing the allocation of the bumps by replacing the vias of the power supplies inside the void with the vias of the ground outside the void.

5. The semiconductor design method as claimed in claim 1, further comprising:
allocating the bumps by respective shortest distances for the I/O sections of the power supplies or the grounds among the multiple I/O sections.

6. The semiconductor design method as claimed in claim 1, further comprising:
displaying, by the computer, a first layout of the chip and a second layout of the package by overlaying or by arranging in parallel the first layout with the second layout.

7. The semiconductor design method as claimed in claim 6, further comprising:
distinguishably displaying, by the computer, the I/O sections, the bumps, and wirings between the I/O sections and the bumps which are related to the power supplies and the grounds, in a case of displaying the first layout and the second layout by overlaying or arranging in parallel the first layout and the second layout.

8. A non-transitory computer-readable recording medium storing a program which, when executed by a computer, causes the computer to perform a semiconductor design process comprising:
assigning bumps to multiple Input and Output (I/O) sections of a chip;
arranging a plane by deploying vias at locations of the bumps which are allocated to I/O sections of power supplies and grounds, with respect to a package on which the chip is mounted; and
changing an allocation of the bumps with respect to the I/O sections of the power supplies and the grounds among the multiple I/O sections based on a number of the vias inside a void formed on the plane.

9. The non-transitory computer-readable recording medium storing a program as claimed in claim 8, wherein
the process further comprising:
determining, by the computer, whether quality of the package is satisfied, by referring to at least one reference level in which a reference of a current loop area is given by a reference number of the vias inside the void; and
reducing, by the computer, a number of the vias of the power supplies adjacent inside the void, by changing an arrangement of the vias inside the void and around the void, when the number of the vias inside the void is unable to satisfy the reference level.

10. The non-transitory computer-readable recording medium storing a program as claimed in claim 9, wherein
the process further comprising
changing, by the computer, the allocation of the bumps to alternately deploy the vias of the power supplies and the grounds.

11. The non-transitory computer-readable recording medium storing a program as claimed in claim 10, wherein
the process further comprising
changing the allocation of the bumps by replacing the vias of the power supplies inside the void with the vias of the ground outside the void.

12. The non-transitory computer-readable recording medium storing a program as claimed in claim 9, wherein
the process further comprising
allocating the bumps by respective shortest distances for the I/O sections of the power supplies or the grounds among the multiple I/O sections.

13. The non-transitory computer-readable recording medium storing a program as claimed in claim 9, wherein
the process further comprising
displaying, by the computer, a first layout of the chip and a second layout of the package by overlaying or by arranging in parallel the first layout with the second layout.

14. The non-transitory computer-readable recording medium storing a program as claimed in claim 13, wherein
the process further comprising
distinguishably displaying, by the computer, the I/O sections, the bumps, and wirings between the I/O sections and the bumps which are related to the power supplies and the grounds, in a case of displaying the first layout and the second layout by overlaying or arranging in parallel the first layout and the second layout.

15. A non-transitory computer-readable recording medium storing a program, wherein:
when the program is executed by a computer, the computer displays a first layout of a chip and a second layout of a package mounted together on a display.

16. The non-transitory computer-readable recording medium storing a program as claimed in claim 15, wherein:
the first layout and the second layout are together displayed on the display by overlaying the first layout and the second layout.

17. The non-transitory computer-readable recording medium storing a program as claimed in claim 15, wherein
the first layout and the second layout are together displayed on the display in parallel.

18. The non-transitory computer-readable recording medium storing a program as claimed in claim 15, wherein
the first layout and/or the second layout include patterns of I/O sections of the chip, bumps and wiring between the I/O sections and the bumps, and the pattern related to power supply and the pattern related to ground are distinguishably displayed on the display.

19. The non-transitory computer-readable recording medium storing a program as claimed in claim 15, wherein
at least one of the first layout and the second layout are displayed on the display in a state enabled to switch to either one of a package top view and a chip top view.

20. The non-transitory computer-readable recording medium storing a program as claimed in claim 15, wherein
at least one of the first layout and the second layout are displayed on the display in a state enabled to switch a layout subject between the chip and the package.
